(19) United States
(12) Patent Application Publication
(10) Pub. No.: US 2026/0217475 A1
(43) Pub. Date: Jul. 30, 2026

(54) Maintenance System And Method For A Rail Conveyor

(71) Applicant: THE UNIVERSITY OF NEWCASTLE, Callaghan (AU)

(72) Inventors: Craig Wheeler, Callaghan, New South Wales (AU); Michael Carr, Callaghan, New South Wales (AU); Peter Robinson, Callaghan, New South Wales (AU)

(73) Assignee: THE UNIVERSITY OF NEWCASTLE, Callaghan (AU)

(21) Appl. No.: 19/159,039

(22) PCT Filed: Feb. 23, 2024
(86) PCT No.: PCT/AU2024/050146

§ 371 Date: Aug. 22, 2025

(30) Foreign Application Priority Data
Feb. 24, 2023 (AU) 2023900487

(51) Int. Cl. B65G 45/00; B65G 21/10; B65G 21/22

(52) U.S. Cl. CPC B65G 45/00; B65G 21/10; B65G 21/22; B65G 2207/30

(57) ABSTRACT

A system (100) for performing maintenance on a rail conveyor (1) has a frame assembly (200) for moving parallel to a rail track (2) and a transportation assembly (300a, 300b) mounted to the frame assembly. The rail conveyor (1) has carriages (5) removably connected to each other by a rope (9) and running along the track (2). The transportation assembly (300a, 300b) moves relative to the frame assembly (200) and into proximity to a selected carriage (50), detaches the selected carriage (5) from the carriages (5) and the rope (9), and removes the selected carriage (5) from the track (2). The system (100) enables an automated and safer system for installing, maintaining and replacing carriages (5) with less interruption to the rail conveyor (1).

### FIELD OF THE INVENTION

The invention relates to a system for performing maintenance on a rail conveyor and in particular to an automated carriage removal and/or replacement system for the rail conveyor. The invention has been developed primarily for use as an automated carriage installation, removal and/or replacement system for a rail conveyor of the type having a plurality of wheeled carriages running along a rail track and removably connected to each other, and will be described hereinafter by reference to this application. However, the invention may be used as a manual system for installation, removal and/or replacement system for the rail conveyor.

### BACKGROUND OF THE INVENTION

The following discussion of the prior art is intended to present the invention in an appropriate technical context and allow its advantages to be properly appreciated.

Unless clearly indicated to the contrary, however, reference to any prior art in this specification should not be construed as an express or implied admission that such art is widely known or forms part of common general knowledge in the field.

There are many advantages to the use of rail conveyor technology for the long distance transportation of bulk materials, as is set out in the Applicant's International patent application PCT/AU2011/000930, published as WO 2012/009765 A1, the contents of which are incorporated by reference. This type of rail conveyor system is designed for the overland transport of bulk materials and has a rail track with a plurality of carriages spaced apart from each other with wheels that run on the rail track. The plurality of carriages supports the conveyor belt and, in one preferred embodiment, are connected together by a common driving rope or cable. The rail track is typically arranged to have a delivery run, where the conveyor belt carries a load from a loading end to a discharge end, and a return run, where the now empty conveyor belt is carried back to the loading end to pick up another load of material.

This rail conveyor system thus replaces idler rolls or rollers that are typically used in conventional belt conveyors in that the carriages support the conveyor belt and run along rails. The benefits of this rail conveyor configuration are that it drastically reduces the energy required to transport bulk material, resulting in more efficient and cost effective transport.

Other variations or improvements to this type of rail conveyor system have been developed. In one variation, the rail track has been arranged so that the carriages are transferred from the delivery run to the return run over a turnover wheel to minimise the footprint of the turnaround loops, as disclosed in International patent application PCT/AU2015/000655, published as WO 2016/065406 A1, the contents of which are incorporated by reference. Another variation provides an enclosed conveyor belt, as disclosed in International patent application PCT/AU2018/051156, published as WO 2019/079859 A1, the contents of which are incorporated by reference.

Maintenance of this type of rail conveyor system requires the carriages to be refurbished at regular intervals, as the carriages may be damaged, become worn or otherwise deteriorate over time. For example, the carriage wheels and seals may need to be replaced due to wear, bearings replaced due to fatigue, and/or rope bushes to be replaced due to wear. This maintenance is usually performed by removing the damaged carriage from the rail conveyor system for refurbishment, rather than maintaining the damaged carriage in the system due to time, cost and safety reasons. The removed carriages can then be maintained, repaired and/or refurbished in a suitably clean environment specifically designed for necessary maintenance operations.

Traditionally, removing the carriage from the rail conveyor system would require the rail conveyor system to be stopped, as well as being electrically and mechanically isolated for safety reasons. The carriage requiring maintenance would then be manually removed and replaced with a refurbished carriage. This process requires significant time to stop and isolate the entire rail conveyor system, as well as requiring additional manual labour to remove and replace the carriages. As a consequence, the need for regular maintenance results in significant down time for the entire rail conveyor system, and incurs additional costs in the required labour and the measures required to ensure safety of the workers.

It is therefore an object of the present invention to overcome or substantially ameliorate one or more of the disadvantages of prior art, or at least to provide a useful alternative. It is an object of the invention in at least one preferred embodiment to provide a system for removing and/or replacing carriages in this type of rail conveyor system with minimal downtime, and preferably provide an automated carriage changeout system to remove the need for additional labour or providing safety measures against hazards.

### SUMMARY OF THE INVENTION

A first aspect of the invention provides a system for performing maintenance on a rail conveyor having a plurality of carriages removably connected to each other, wherein each carriage comprises wheels for running along a rail track, comprising:
a frame assembly configured for moving parallel to the rail track;
a transportation assembly mounted to the frame assembly; the transportation assembly being configured to:
   move relative to the frame assembly and into proximity to a selected carriage of the plurality of carriages;
   detach the selected carriage from the plurality of carriages; and
   remove the selected carriage from the rail track.

In one or more embodiments, the frame assembly is configured to move at substantially the same speed as the plurality of carriages.

In one or more embodiments, the transportation assembly is configured to remove the selected carriage from the rail track as the plurality of carriages move along the rail track.

In one or more embodiments, the transportation assembly comprises a conveyor mechanism for removing the selected carriage from the rail track as the plurality of carriages move along the rail track.

In one or more embodiments, the conveyor mechanism comprises a lifting mechanism for lifting the selected carriage from the rail track. In one or more embodiments, the lifting mechanism comprises a mechanical lifting device. In one or more embodiments, the mechanical lifting device comprises a scissor lift, hoist, telescopic arm, telescopic crane or lifting arm.

In one or more embodiments, the conveyor mechanism comprises a carriage connecting member for removably connecting the lifting mechanism to the selected carriage. In one or more embodiments, the carriage connecting member comprises one or more carriage engagement members. In one or more embodiments, the plurality of carriage connecting members comprises one or more removable locking elements for securing the selected carriage to the lifting mechanism. In one or more embodiments, the one or more removable locking elements comprise hooks, clamps, latches, electromagnets or removable fasteners.

In one or more embodiments, the carriage connecting member comprises one or more frame guide members for guiding the carriage engagement member into engagement with the selected carriage. In one or more embodiments, the one or more frame guide members extend along the sides of the selected carriage. In one or more embodiments, the one or more frame guide members guide the selected carriage to a position substantially perpendicular to the rail track. In one or more embodiments, the one or more frame guide members have a triangular or wedge shape.

In one or more embodiments, the carriage connecting member comprises one or more locating members for locating the selected carriage relative to the conveyor mechanism. In one or more embodiments, the one or more locating members to locate the selected carriage inline or axially aligned with the rail track. In one or more embodiments, the one or more locating members engage at least one axle of the selected carriage. In one or more embodiments, the one or more locating members comprise a detent portion for engaging the at least one axle.

In one or more embodiments, the transportation assembly comprises a transfer mechanism for detaching the selected carriage from the plurality of carriages.

In one or more embodiments, the plurality of carriages is spaced apart from each other and are each removably connected to a rope, the transfer mechanism being configured to detach the rope from the selected carriage.

In one or more embodiments, the transfer mechanism comprises a first rope engagement member for engaging the rope and detaching the rope from the selected carriage.

In one or more embodiments, the first rope engagement member is connected to a first actuator for moving the rope engagement member into and out of engagement with the rope. In one or more embodiments, the first actuator comprises an actuator arm connected to a drive member, the first rope engagement member being pivotally connected to the actuator arm such that the drive member operates the actuator arm to pivot the first rope engagement member.

In one or more embodiments, the first rope engagement member comprises a catch portion for capturing the rope and a transfer arm for moving the rope from the catch portion to a receiving portion. In one or more embodiments, the catch portion is located at or proximate to one end of the first rope engagement member and the receiving portion is located at or proximate to the opposite end of the first rope engagement member.

In one or more embodiments, the catch portion captures the rope, the transfer arm moves the rope from the catch portion to the receiving portion and the receiving portion releases the rope to detach the rope from the selected carriage.

In one or more embodiments, the transfer mechanism is configured to attach the rope to a replacement carriage. In one or more embodiments, the receiving portion of the second transportation assembly receives the rope. In one or more embodiments, the transfer arm moves the rope to the catch portion. In one or more embodiments, the catch portion releases the rope into a holding portion of the replacement carriage.

In one or more embodiments, the first actuator comprises an actuator arm pivotally connected to the first rope engagement member such that the actuator arm pivots the first rope engagement member to displace the rope from the selected carriage. In one or more embodiments, the system further comprises a transfer arm operably connected to a transfer actuator, wherein the transfer arm removes the rope from the first rope engagement member, thereby detaching the rope from the selected carriage.

In one or more embodiments, the first rope engagement member moves the rope out of a holding portion of the selected carriage. In one or more embodiments, the transfer actuator moves the transfer arm so that it engages the rope held by the first rope engagement member and moves it along the first rope engagement member.

In one or more embodiments, the transfer mechanism is configured to attach the rope to a replacement carriage. In one or more embodiments, the transfer mechanism comprises a second rope engagement member for engaging the rope and attaching the rope to the replacement carriage. In one or more embodiments, the second rope engagement member is connected to a second actuator for moving the rope engagement member into and out of engagement with the rope.

In one or more embodiments, the transfer mechanism comprises a rope guide for guiding movement of the rope. In one or more embodiments, the rope guide is movable to guide the rope into engagement with the second rope engagement member. In one or more embodiments, the rope guide is movable to move the rope relative to the second rope engagement member such that the second rope engagement member is able to release the rope into a holding portion of the replacement carriage, thereby attaching the rope to the replacement carriage. In one or more embodiments, the rope guide is connected to a rope guide actuator for moving the rope guide. In one or more embodiments, the rope guide actuator pivots the rope guide. The rope guide may have at least two arms. In one or more embodiments, the rope guide may be in the form of a yoke or have a Y-shape.

In one or more embodiments, the rope guide moves into engagement with the rope and then moves the rope to a first intermediate position. In one or more embodiments, the second actuator moves the second rope engagement member into engagement with the rope in the first intermediate position. In one or more embodiments, the second rope engagement member moves the rope along the rope guide to a second intermediate position. The second intermediate position is preferably above and laterally displaced from the holding portion. In one or more embodiments, the rope guide moves the rope along the second rope engagement member to a third intermediate position, preferably towards the holding portion. In one or more embodiments, the second rope engagement member disengages from the rope so that is released into the holding portion. In embodiments where the rope guide comprises two arms, the rope guide moves the rope into the first intermediate position using one arm and moves the rope into the third intermediate position using the other arm.

In one or more embodiments, there may be a plurality of the second rope engagement members. In one or more embodiments, there may be a plurality of the rope guides.

In one or more embodiments, the selected carriage comprises a locating member for locating the rope in a holding portion, and the transfer mechanism comprises a pivot member for moving the locating member to enable the rope to leave the holding portion. The pivot member may also move the locating member to provide a clearance space for the rope engagement member to engage and detach the rope from the selected carriage. In one or more embodiments, the pivot member is connected to the actuator arm such that movement of the actuator arm causes the pivot member to move the locating member.

In one or more embodiments, the selected carriage comprises a locating member for locating the rope in a holding portion of the selected carriage, wherein a transfer assembly is configured to move the locating member to enable the rope to leave the holding portion. The transfer assembly may also move the locating member to provide a clearance space for the first rope engagement member to engage and detach the rope from the selected carriage. In one or more embodiments, the transfer assembly comprises a transfer arm operably connected to a transfer rod such that the transfer arm moves the transfer rod to engage and move the locating member. In one or more embodiments, the transfer assembly comprises an actuator for moving the transfer arm. In one or more embodiments, the actuator comprises an actuator rod connected to the transfer arm. In one or more embodiments, the actuator arm is pivotally connected to the actuator rod. In one or more embodiments, the transfer arm pivots or rotates to cause the transfer rod to move into engagement with the locating member.

In one or more embodiments, the transfer mechanism comprises a support arm for connecting the transfer mechanism to the conveyor mechanism.

In one or more embodiments, the carriage (including the selected carriage and/or replacement carriage) may have a tension spring or compression spring mounted to the rope. In one or more embodiments, the carriage (including the selected carriage and/or replacement carriage) comprises one or more tension springs or compression springs mounted to a frame of the carriage. In one or more embodiments, there are one or more dampening elements adjacent the one or more tension springs or compression springs (on the rope or mounted to the carriage). In one or more embodiments, the one or more dampening elements are mounted in series with the one or more tension springs or compression springs.

In one or more embodiments, the carriage comprises one or more support beams for restricting movement of the tension spring or compression spring. In one or more embodiments, the one or more support beams are arranged on either side of the tension spring or compression spring. In one or more embodiments, the one or more support beams are resistant to loading forces induced by movement of the rope. This may occur when the rope changes direction in response to the carriages moving along horizontal curved portions and the turnaround portions of the rail track. In one or more embodiments, the one or more support beams comprise tubular beams, or pipe-like beams, or rods, preferably to act as guides for movement of the holding assembly. In one or more embodiments, the one or more tension springs or compression springs are mounted to at least one of the support beams.

In one or more embodiments, the carriage comprises a holding assembly for holding the rope and securing the carriage to the rope. In one or more embodiments, the holding assembly is moveable relative to the carriage. In one or more embodiments, the holding assembly is slidable relative to the carriage. In one or more embodiments, the movement of the holding assembly movement is restricted by the tension or compression spring and/or support beams.

In one or more embodiments, there are a plurality of the transportation assemblies, comprising at least a first transportation assembly and a second transportation assembly, wherein the first transportation assembly is operable to remove the selected carriage and the second transportation assembly is operable to replace the selected carriage with a replacement carriage. The replacement carriage may be a new carriage or a refurbished carriage.

In one or more embodiments, the second transportation assembly is mounted to the frame assembly for movement along the same path as the first transportation assembly. In one or more embodiments, the second transportation assembly follows the first transportation assembly on the frame assembly.

In one or more embodiments, the second transportation assembly comprises a second conveyor mechanism operable to move a replacement carriage onto the rail track as the plurality of carriages move along the rail track.

In one or more embodiments, the second transportation assembly comprises a second transfer mechanism operable to attach the replacement carriage to the plurality of carriages.

In one or more embodiments, the second transfer mechanism has a second rope engagement member operable to move the rope into engagement with the replacement carriage. In one or more embodiments, the second transfer mechanism comprises a receiving portion for receiving the rope and a transfer arm for moving the rope to a catch portion for releasing the rope into a holding portion of the replacement carriage.

In one or more embodiments, the system comprises a support track comprising rails extending parallel to the rail track, wherein the frame assembly is moveable along the support track. In one or more embodiments, the support track is elevated above the rail track. In one or more embodiments, the support track has a width greater than the width of the rail track.

In one or more embodiments, the transportation assembly is mounted to the frame assembly for movement substantially transverse to the direction of the rail track.

In one or more embodiments, the frame assembly comprises a bridge portion extending between the rails of the support track and a plurality of wheels for moving the bridge portion along the support track.

In one or more embodiments, the transportation assembly is mounted to the bridge portion for movement substantially transverse to the direction of the rail track. In one or more embodiments, the first transportation assembly and/or second transportation assembly are mounted to the bridge portion for movement substantially transverse to the direction of the rail track.

In one or more embodiments, the bridge portion comprises at least two spaced apart rails defining a bridge track for supporting the first transportation assembly and/or second transportation assembly, wherein the first transportation assembly and/or second transportation assembly have wheels for running along the rails of the bridge track. In one or more embodiments, the bridge portion comprises at least two bridge tracks, a first bridge track supporting the first transportation assembly and a second bridge track supporting the second transportation assembly.

In one or more embodiments, the frame assembly is elevated above the rail track.

In one or more embodiments, the frame assembly and transportation assembly are in electronic communication with a controller, wherein the controller sends signals to the frame assembly and transportation assembly to control movement of the frame assembly and operation of the transportation assembly. In one or more embodiments, the controller is in electronic communication with the conveyor mechanism and the transfer mechanism. Where there is a plurality of transportation assemblies, the controller is in electronic communication with each of the plurality of transportation assemblies, and preferably is in electronic communication with the conveyor mechanisms and the transfer mechanisms of each respective transportation assembly.

In one or more embodiments, the controller comprises a computer, programmable logic controller (PLC) or central processing unit (CPU) to automate operation of the system.

A second aspect of the invention provides a system for performing maintenance on a rail conveyor having a plurality of carriages removably connected to each other, wherein each carriage comprises wheels for running along a rail track, comprising:
a frame assembly configured for moving parallel to the rail track at substantially the same speed as the plurality of carriages;
a transportation assembly mounted to the frame assembly; the transportation assembly being configured to:
   move relative to the frame assembly and into proximity to a selected carriage of the plurality of carriages;
   detach the selected carriage from the plurality of carriages; and
   remove the selected carriage from the rail track as the plurality of carriages move along the rail track.

One or more embodiments of the second aspect may have the features of one or more embodiments of the first aspect of the invention stated above, where applicable.

A third aspect of the invention provides a carriage removal system for a rail conveyor having a plurality of carriages removably connected to each other, wherein each carriage comprises wheels for running along a rail track, comprising:
a frame assembly configured for moving parallel to the rail track at substantially the same speed as the plurality of carriages; and
a first transportation assembly mounted to the frame assembly; the transportation assembly being configured to move relative to the frame assembly and into proximity to a selected carriage of the plurality of carriages;
the first transportation assembly comprising:
   a conveyor mechanism for removing the selected carriage from the rail track as the plurality of carriages move along the rail track; and
   a transfer mechanism for detaching the selected carriage from the plurality of carriages.

One or more embodiments of the third aspect may have the features of one or more embodiments of the first and/or second aspects of the invention stated above, where applicable.

A fourth aspect of the invention provides a carriage replacement system for a rail conveyor having a plurality of carriages removably connected to each other, wherein each carriage comprises wheels for running along a rail track, comprising:
a frame assembly configured for moving parallel to the rail track at substantially the same speed as the plurality of carriages;
a first transportation assembly mounted to the frame assembly; the first transportation assembly being configured to move relative to the frame assembly and into proximity to a selected carriage of the plurality of carriages;
the first transportation assembly comprising:
   a first conveyor mechanism for removing the selected carriage from the rail track as the plurality of carriages move along the rail track; and
   a first transfer mechanism for detaching the selected carriage from the plurality of carriages; and
a second transportation assembly mounted to the frame assembly; the second transportation assembly being configured to move relative to the frame assembly and into proximity to a space left by the removed selected carriage;
the second transportation assembly comprising:
   a second conveyor mechanism for moving a replacement carriage onto the rail track and into the space as the plurality of carriages move along the rail track; and
   a second transfer mechanism for attaching the replacement carriage to the plurality of carriages.

One or more embodiments of the first and second transfer mechanisms may have the features of one of more embodiments of the transfer mechanism of the first aspect.

One or more embodiments of the fourth aspect may have the features of one or more embodiments of the first, second or third aspects of the invention stated above, or any combination thereof, where applicable.

A fifth aspect of the invention provides a method for performing maintenance on a rail conveyor having a plurality of carriages removably connected to each other, wherein each carriage comprises wheels for running along a rail track, the method comprising the steps of:
moving a frame assembly parallel to the rail track at substantially the same speed as the plurality of carriages;
moving a transportation assembly relative to the frame assembly into proximity to a selected carriage of the plurality of carriages;
detaching the selected carriage from the plurality of carriages; and
removing the selected carriage from the rail track as the plurality of carriages move along the rail track.

In one or more embodiments, the moving step comprises moving the frame assembly at substantially the same speed as the plurality of carriages.

In one or more embodiments, the removing step comprises removing the selected carriage from the rail track as the plurality of carriages move along the rail track.

In one or more embodiments, the transportation assembly has a conveyor mechanism comprising that performs the removing step. In one or more embodiments, the removing step comprises lifting the selected carriage from the rail track.

In one or more embodiments, the removing step comprises removably locking the selected carriage to the conveyor mechanism to securing the selected carriage prior to removing the selected carriage.

In one or more embodiments, the transportation assembly has a transfer mechanism that performs the detaching step.

In one or more embodiments, the plurality of carriages are spaced apart from each other and are each removably connected to a rope, the detaching step comprising detaching the rope from the selected carriage.

In one or more embodiments, the detaching step comprises engaging the rope, moving the engaged rope into a receiving portion of the transfer mechanism.

In one or more embodiments, the detaching step comprises locating the transfer mechanism relative to the selected carriage.

In one or more embodiments, there are a plurality of the transportation assemblies, comprising at least a first transportation assembly and a second transportation assembly, and the first transportation assembly performs the detaching and removing steps, the method further comprising replacing the selected carriage with a replacement carriage using the second transportation assembly.

In one or more embodiments, the method further comprises moving the second transportation assembly along the same path as the first transportation assembly. In one or more embodiments, the method further comprises arranging the second transportation assembly to follow the first transportation assembly on the frame assembly.

In one or more embodiments, the replacing step comprises moving a replacement carriage onto the rail track as the plurality of carriages move along the rail track.

In one or more embodiments, the moving step is performed by the conveyor mechanism of the second transport assembly. In one or more embodiments, the removing step comprises lowering the replacement carriage onto the rail track into the space left by the selected carriage in the plurality of carriages.

In one or more embodiments, wherein the replacing step comprises attaching the replacement carriage to the plurality of carriages.

In one or more embodiments, the attaching step is performed by the transfer mechanism of the second transport assembly.

In one or more embodiments, the attaching step comprises engaging the rope, moving the engaged rope to a catch portion of the transfer mechanism of the second transport assembly and releasing the rope from the catch portion into a holding portion of the replacement carriage.

In one or more embodiments, the method further comprises moving the frame assembly along a support track comprising rails extending parallel to the rail track. In one or more embodiments, the method further comprises elevating the support track above the rail track.

In one or more embodiments, the method further comprises mounting the transportation assembly to the frame assembly and moving the transportation assembly substantially transverse to the direction of the rail track.

In one or more embodiments, the method further comprises moving the first transportation assembly and/or second transportation assembly substantially transverse to the direction of the rail track.

One or more embodiments of the fifth aspect may have the features of one or more embodiments of the first, second, third or fourth aspects of the invention stated above, or any combination thereof, where applicable.

A sixth aspect of the invention provides a method for performing maintenance on a rail conveyor having a plurality of carriages removably connected to each other, wherein each carriage comprises wheels for running along a rail track, the method comprising the steps of:
moving a frame assembly parallel to the rail track at substantially the same speed as the plurality of carriages;
moving a transportation assembly relative to the frame assembly into proximity to a selected carriage of the plurality of carriages;
detaching the selected carriage from the plurality of carriages; and
removing the selected carriage from the rail track as the plurality of carriages move along the rail track.

One or more embodiments of the sixth aspect may have the features of one or more embodiments of the first, second, third, fourth or fifth aspects of the invention stated above, or any combination thereof, where applicable.

It will also be appreciated that the conveyor mechanism, transfer mechanism and transfer assembly as described above in the embodiments of the various aspects of the invention may also be individual aspects of the invention. That is, according to other aspects of the invention, there may be provided a conveyor mechanism, a transfer mechanism and/or a transfer assembly for a transportation assembly, as described above. Similarly, the carriages as described above may also constitute separate aspects of the invention.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### BRIEF DESCRIPTION OF THE DRAWINGS

Preferred embodiments of the invention will now be described, by way of example only, with reference to the accompanying drawings in which:

FIG. 1A is a schematic perspective view of a rail conveyor for use with embodiments of the invention;

FIG. 1B is a schematic perspective view of an alternative rail conveyor for use with embodiments of the invention;

FIG. 2 is a schematic perspective view of a carriage used in the rail conveyor of FIGS. 1A and 1B;

FIG. 3A is a schematic perspective view of a rail track used in FIG. 1A incorporating a system for maintaining a rail conveyor according to an embodiment of the invention;

FIG. 3B is schematic perspective view of a maintenance shed housing the system for maintaining a rail conveyor according to this embodiment of the invention;

FIG. 4 is a schematic cross-sectional side view of the system of FIG. 3;

FIG. 5 is a schematic end view of the system of FIG. 3;

FIG. 6 is a schematic top plan view of the system of FIG. 3;

FIG. 7 is a schematic partial perspective view of transportation assemblies used in the system of FIG. 3;

FIG. 8 is another schematic end view of the system of FIG. 3;

FIG. 9 is a schematic partial close up perspective view of the transportation assembly of FIG. 7;

FIG. 10 is a schematic partial close up perspective view of a conveyor mechanism used by the transportation assembly of FIG. 7;

FIG. 11A is a schematic partial close up perspective view of the removable locking elements used by the conveyor mechanism of FIG. 10 in a first state;

FIG. 11B is a schematic partial close up perspective view of the removable locking elements of FIG. 11A in a second state;

FIGS. 12A and 12B are schematic partial close up front perspective views of the connection of the carriage and the rope in the rail conveyor;

FIG. 13 is a schematic partial close up rear perspective view of the connection of the carriage and the rope in the rail conveyor;

FIG. 14A is a schematic partial close up underneath perspective view of the holding assembly of the carriage in a closed state;

FIG. 14B is a schematic partial close up underneath perspective view of the holding assembly of the carriage in an open state;

FIG. 15 is a schematic partial close up front view of a transfer mechanism of the transportation assembly of FIG. 7;

FIG. 16 is a schematic partial close up front view of the transfer mechanism of FIG. 15 in a first state;

FIG. 17 is a schematic partial close up front view of the transfer mechanism of FIG. 15 in a second state;

FIG. 18 is a schematic partial close up front view of the transfer mechanism of FIG. 15 in a third state;

FIG. 19 is a schematic partial close up front view of the transfer mechanism of FIG. 15 in a fourth state;

FIG. 20 is a schematic partial close up front view of the transfer mechanism of FIG. 15 in a fifth state;

FIG. 21 is a schematic partial close up front view of the transfer mechanism of FIG. 15 in a sixth state;

FIG. 22 is a schematic partial perspective view of an alternative frame assembly and transportation assembly arrangement in a system according to another embodiment of the invention;

FIG. 23 is a schematic top plan view of the system of FIG. 22;

FIG. 24 is a schematic cross-sectional side view of the system of FIG. 22; and

FIG. 25 is another schematic partial perspective view of the system of FIG. 22.

FIGS. 26 and 27 are schematic perspective views of two different alternative embodiments of the carriage for use in the rail conveyor;

FIGS. 28A and 28B are schematic partial close up perspective views of the holding assembly of the carriage of FIG. 27;

FIG. 28C is a schematic partial close up underneath perspective view of the holding assembly of the carriage of FIG. 27 in a closed state;

FIG. 28D is a schematic partial close up underneath perspective view of the holding assembly of the carriage of FIG. 27 in an open state;

FIG. 29 is a schematic perspective view of a further alternative embodiment of the carriage for use in the rail conveyor;

FIG. 30 is a schematic perspective view of an alternative transfer assembly for releasing and securing a rope from a carriage in a closed position;

FIG. 31 is a schematic perspective view of the alternative transfer assembly in an open position;

FIG. 32 is a schematic sectional view of the transfer mechanism of FIG. 30 in the closed position;

FIG. 33 is a schematic sectional view of the transfer mechanism of FIG. 30 in a first state;

FIG. 34 is a schematic sectional view of the transfer mechanism of FIG. 30 in a second state;

FIG. 35 is a schematic sectional view of the transfer mechanism of FIG. 30 in the open position;

FIG. 36 is a schematic sectional view of a rope removal mechanism of an alternative transfer mechanism in an initial state;

FIG. 37 is a schematic sectional view of the rope removal mechanism of FIG. 36 in a first state;

FIG. 38 is a schematic sectional view of the rope removal mechanism of FIG. 36 in a second state;

FIG. 39 is a schematic sectional view of the rope removal mechanism of FIG. 36 in a third state;

FIG. 40 is a schematic sectional view of the rope removal mechanism of FIG. 36 in a fourth state;

FIG. 41 is a schematic sectional view of a rope placement mechanism of an alternative transfer mechanism in an initial state;

FIG. 42 is a schematic sectional view of the rope placement mechanism of FIG. 41 in a first state;

FIG. 43 is a schematic sectional view of the rope placement mechanism of FIG. 41 in a second state;

FIG. 44 is a schematic sectional view of the rope placement mechanism of FIG. 41 in a third state;

FIG. 45 is a schematic sectional view of the rope placement mechanism of FIG. 41 in a fourth state;

FIG. 46 is a schematic sectional view of the rope placement mechanism of FIG. 41 in a fifth state;

FIG. 47 is a schematic sectional view of the rope placement mechanism of FIG. 41 in a sixth state;

FIG. 48 is a schematic sectional view of the rope placement mechanism of FIG. 41 in a seventh state;

FIG. 49 is a schematic perspective view of an alternative conveyor mechanism for the transportation assembly according to a further embodiment of the invention;

FIG. 50 is a schematic side view of another alternative conveyor mechanism for the transportation assembly according to a further embodiment of the invention;

FIG. 51 is a schematic sectional view of conveyor mechanism of FIG. 49; and

FIG. 52 is a schematic partial close up view of a frame guide of the conveyor mechanism of FIG. 49.

### PREFERRED EMBODIMENTS OF THE INVENTION

The present invention will now be described with reference to the following examples which should be considered in all respects as illustrative and non-restrictive.

Although the invention has been described with reference to specific examples, it will be appreciated by those skilled in the art that the invention may be embodied in many other forms. In the Figures, corresponding features within the same embodiment or common to different embodiments have been given the same reference numerals.

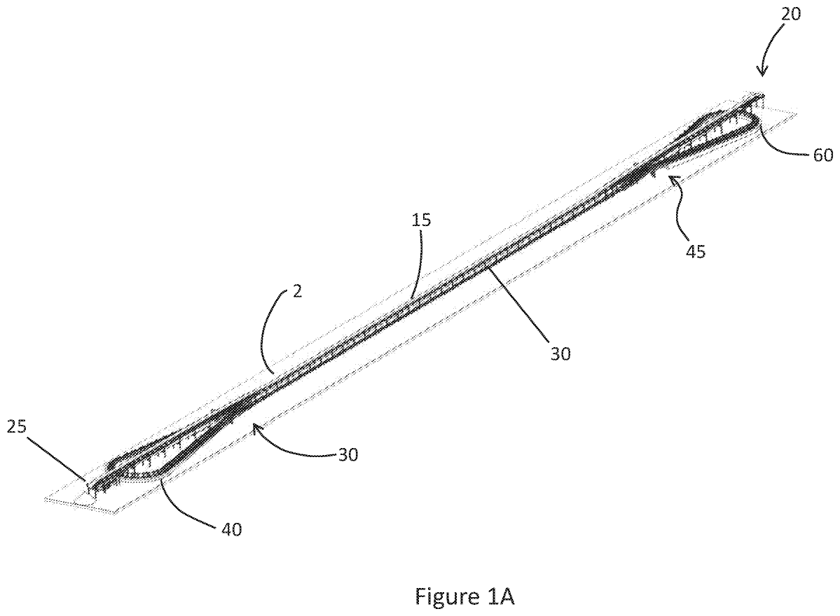

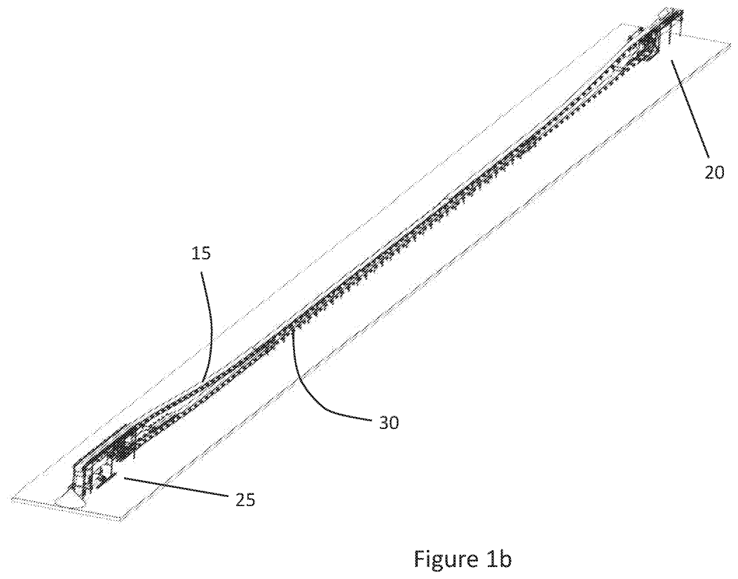

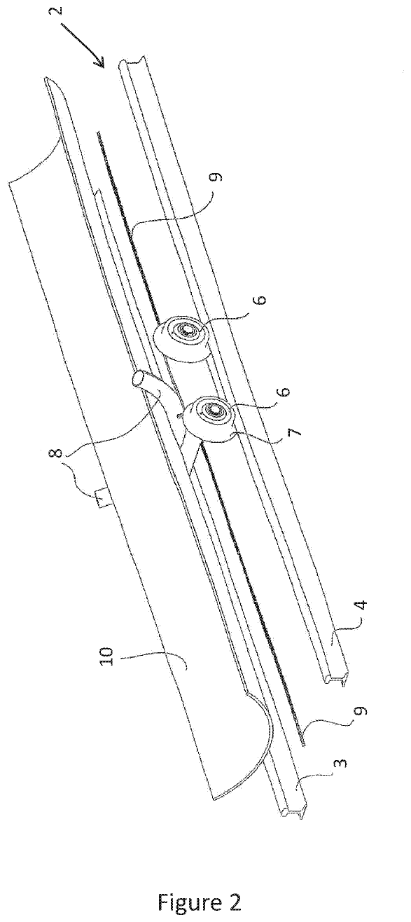

Referring to FIGS. 1A and 1B a rail conveyor 1 for use with preferred embodiments of the invention is illustrated. The rail conveyor 1 comprises a rail track 2 comprising spaced apart rails 3, 4 and, as best shown in FIG. 2, a plurality of carriages 5 spaced apart from one another and arranged to run on wheels 6 supported by the rail track 2. A continuous carry or conveyor belt 10 is supported by the carriages 5 on the rail track 2 and transports bulk material, such as coal or mineral ore, along a delivery run 15 between a loading end 20 and a discharge end 25. The coal or mineral ore is loaded onto the belt 10 at the loading end 20 and carried by the delivery run 15 towards the discharge end 25, where the bulk material is unloaded. The empty belt 10 is supported by the carriages 15 along a return run 30 between the loading end 20 and the discharge end 25. The delivery run 15 and the return run 30 are arranged one above other.

In the embodiment shown in FIG. 1A, the delivery run 15 is typically separated from the support carriages at approximately position 30 so that bulk material conveyed on the delivery run of the carry belt may be discharged at the discharge end 25 while the carriages 5 on the rail track 2 are sent around a turnaround loop 40 before being reunited with the carry belt 10 in the return run 30 at location 30. There is also a corresponding location 45 at the loading end 20, where the belt 10 is separated from the carriages 5 so that the belt 10 may receive a load of bulk material and the carriages are sent on another turnaround loop 60 to be reunited with the belt at location 50. However, in the embodiment shown in FIG. 1B, there is no horizontally arranged turnaround loop as the carriages 5 are separated from the belt 10 at both the loading and discharge ends 20, 25 and are turned over vertically to be reunited with the belt.

As can be more clearly seen in FIG. 2, the rail track 2 preferably incorporates two side-by-side conventional rails 3 and 4. These rails may be of a similar type to that used in conventional train rail tracks and may either be mounted on the ground on sleepers as for a conventional rail track system or elevated and supported on frames as is well-known for typical belt conveyor systems. The wheels 6 are typically flanged as can be seen at 7 and engage the inside edges of the rails 3 and 4 in a similar manner to a conventional train system. The carriages 5 also have a suitably shaped yoke 8 mounted on each carriage for supporting the belt 10, and in some embodiments, there may be two yokes at either end of each carriage.

Although it is possible to connect the carriages 5 solely by their attachment, either by rigid connection or by friction to the carry belt 10, in this embodiment of the invention the carriages 5 are spaced apart from each other and are preferably connected together by a rope 9. The rope 9 can be a driving rope to pull the carriages 5 (and hence the belt 10) along the delivery and return runs, 15, 30. However, it is preferred that the belt 10 drives the carriages 5 via friction. In this case, the rope 9 pulls the carriages 5 at a set spacing or distance between each other around the end turnaround loops 40, 60 when the belt is not engaged with the carriages. The rope is typically a wire rope (preferably made of steel), but in other embodiments, fibre ropes, cables, cords, lines or ties. Typically, the rope 9 is of sufficient load bearing capacity to pull the carriages 5.

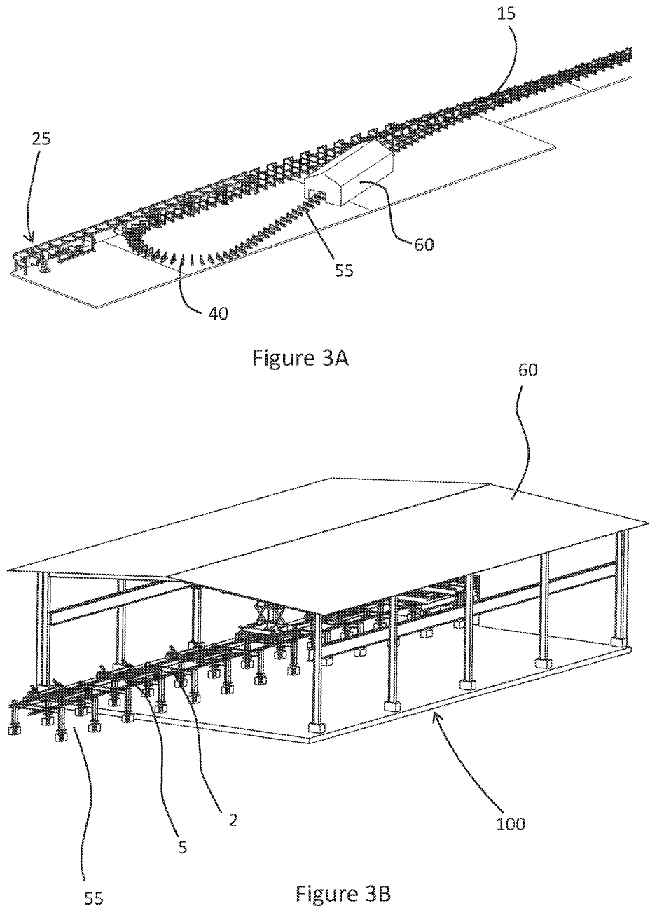

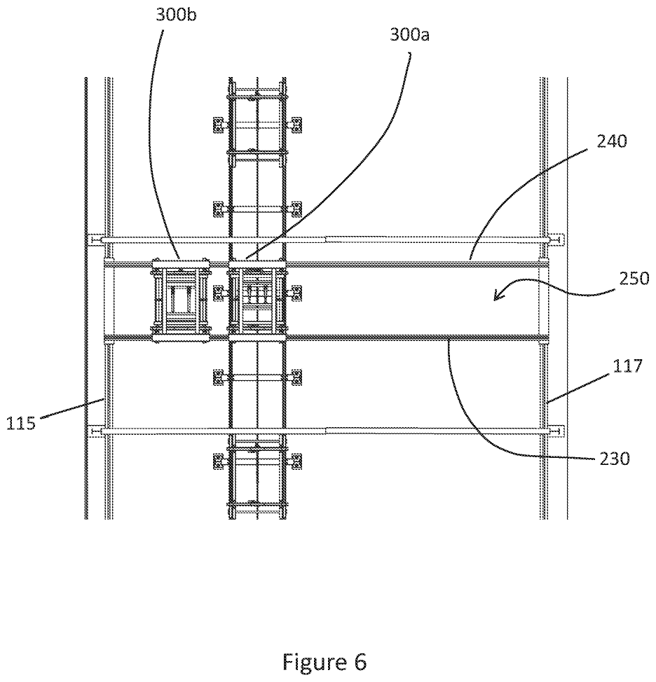

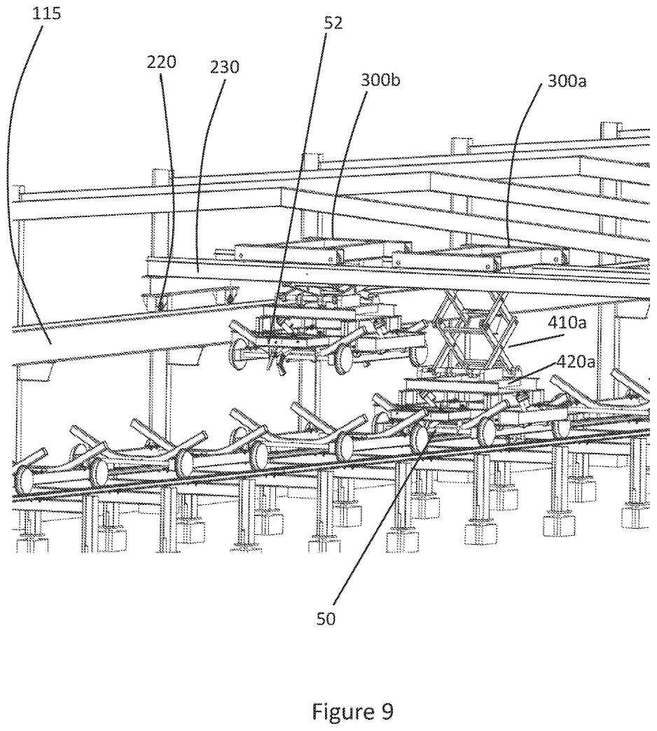

Referring to FIGS. 3A to 21, a system 100 for performing maintenance on the rail conveyor 1 comprises a frame assembly 200 configured for moving parallel to the rail track 2 at substantially the same speed as the plurality of carriages 5 and at least one transportation assembly 300a mounted to the frame assembly. A first transportation assembly 300a is configured to move relative to the frame assembly 200 and into proximity to a selected carriage 50 of the plurality of carriages; detach the selected carriage from the plurality of carriages; and remove the selected carriage from the rail track 2 as the plurality of carriages move along the rail track 2. In this embodiment, there is also a second transportation assembly 300b configured to replace the selected carriage 50 with a replacement carriage 52. The first and second transportation assemblies 300a, 300b are arranged in series or side by side configuration on the rail track 2. The first and second transportation assemblies 300a, 300b are identical in structure and operation and can be viewed as two transportation assemblies of the same type, but performing slightly different functions as discussed in more detail below. The system 100 is thus a combined removal and replacement carriage system, which may also be called a carriage changeout system.

The system 100 is integrated into the rail track 2 of the rail conveyor 1 at the loading end 20 or the discharge end 25 in a straight maintenance section 55 of the rail track of the turnaround loops 40, 60, as best shown in FIGS. 3A and 3B. These locations are preferred since the belt 10 is not being supported by the carriages 5 in the turnaround loops 40, 60. At the loading and discharge ends 20, 25, the belt 10 is separated from the carriages 5 to either receive a load of bulk material or deliver the load. Hence, the carriages 5 are free of the conveyor belt 10 and enable removal and replacement of any damaged or broken carriages that require repair or refurbishment. A maintenance shed 60 is placed on the maintenance section 55 that houses the system 100. The carriages 5 in this embodiment have a yoke 8 at each end of the carriage, although in other applications the carriages may have a single yoke.

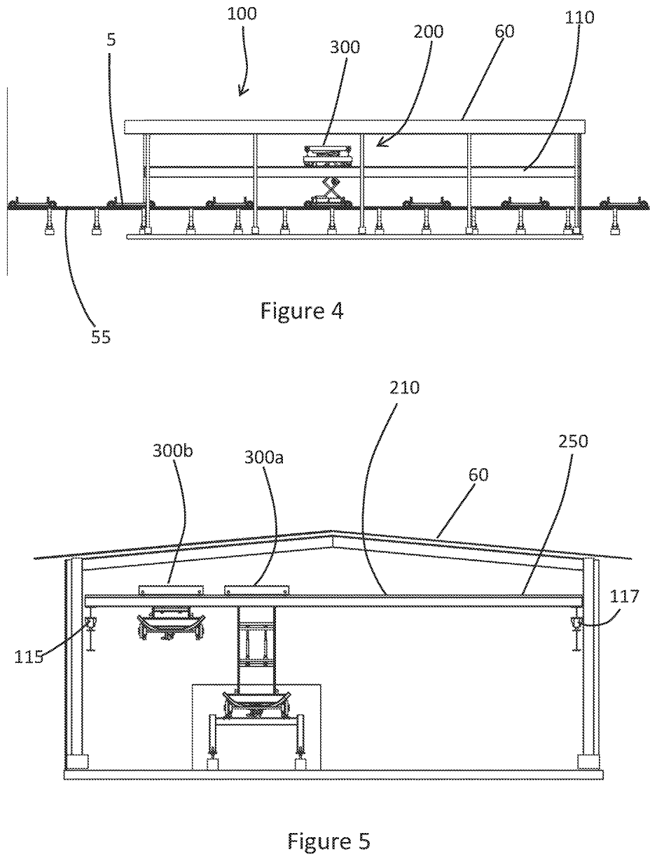

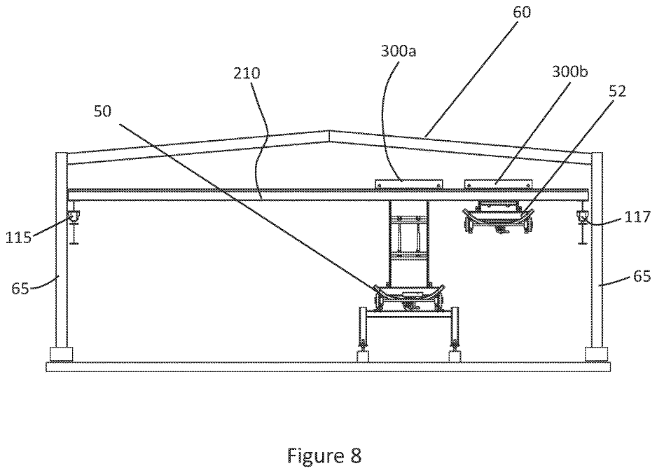

The system 100 comprises a support track 110 comprising rails 115, 117 extending parallel to the rail track 2, as best shown in FIGS. 4 and 5. The frame assembly 200 is moveable along the support track 110. The support track 110 is elevated above the rail track 2, preferably by mounting the rails 115, 117 to sidewalls 65 of the maintenance shed 60, as best shown in FIG. 8. However, the support track 110 may be elevated by separate supporting pylons or posts. The support track 110 preferably has a width greater than the width of the rail track 2. In addition, the transportation assemblies 300a, 300b are preferably mounted to the frame assembly 200 for movement substantially transverse to the direction of the rail track 2. This configuration of the support track 110 and mounting of the frame assembly 200 enables the transportation assemblies 300a, 300b to move to either side of the rail track 2 and overhang the carriages 5 via the frame assembly 200.

The frame assembly 200 comprises a bridge portion 210 extending between the rails 115, 117 of the support track 110 and a plurality of wheels 220 for moving the bridge portion along the support track, as best shown in FIGS. 5 to 8. In this embodiment, the bridge portion 210 is in the form of a gantry, having two spaced apart rails 230, 240 defining a bridge track 250 for supporting the first transportation assembly 300a and the second transportation assembly 300b. Both the first and second transportation assemblies 300a, 300b have wheels (not shown) for running along the rails 230, 240 of the bridge track 250.

In this embodiment, each transportation assembly 300a, 300b comprises a conveyor mechanism 400a, 400b for removing the selected carriage 50 from the rail track 2 and/or moving the replacement carriage 52 onto the rail track as the plurality of carriages 5 move along the rail track. Each transportation assembly 300a, 300b also comprises a transfer mechanism 500a, 500b for detaching the selected carriage 50 from the plurality of carriages 5 or attaching the replacement carriage 52 to the plurality of carriages. For ease of reference, the detailed operation of the conveyor mechanisms 400a, 400b and transfer mechanisms 500a, 500b will be discussed in relation to the first transportation assembly 300a. However, it will be appreciated that this description equally applies to their counterpart elements in the second transportation assembly 300b.

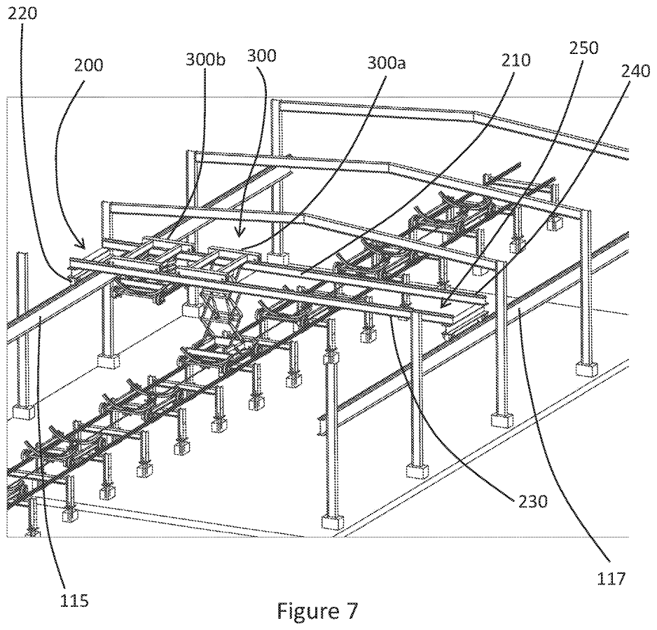

Referring to FIGS. 7, 9 and 10, the conveyor mechanism 400a comprises a lifting mechanism 410a for lifting the selected carriage 50 from the rail track 2. In this embodiment, the lifting mechanism comprises a mechanical lifting device, in the form of a scissor lift 410. However, in other embodiments, a non-mechanical lifting device may be used such as a vacuum or electromagnetic lift, or other types of mechanical lifting devices may be used, such as a hoist, telescopic crane or lifting arm.

The scissor lift 410a in this embodiment comprises a carriage connecting member 420a for removably connecting the lifting mechanism 410a to the selected carriage 50. In this embodiment, the carriage connecting member 420a comprises a carriage connecting frame having carriage engagement members 425a, 426a connected to side frame members 427a, 428a. One of the carriage engagement members 425a may comprise a channel or sleeve for engaging one of the yokes 8 of the selected carriage 50. In some embodiments, the other carriage engagement member 426a has a corresponding channel to engage the other yoke 8.

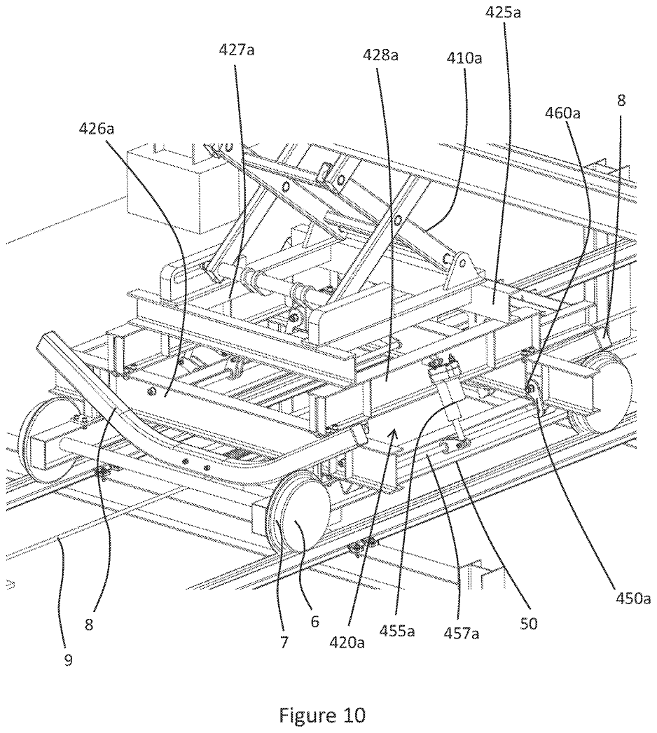

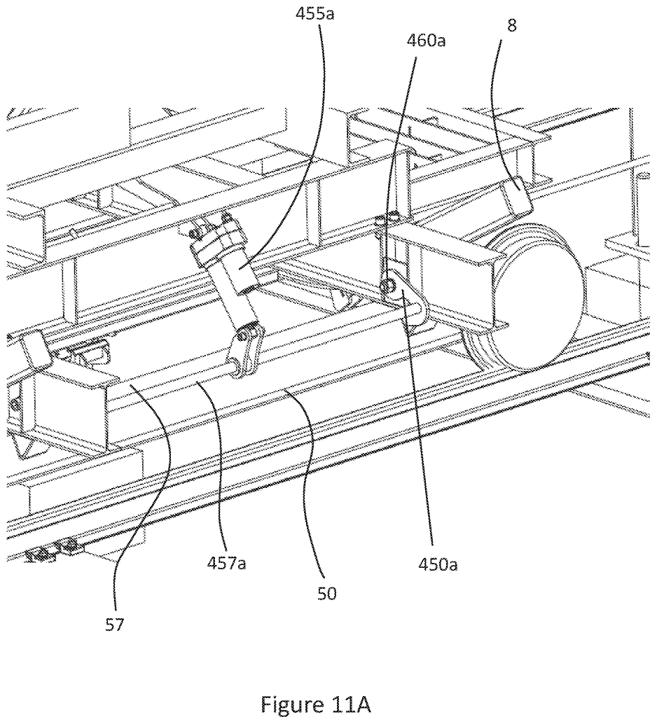

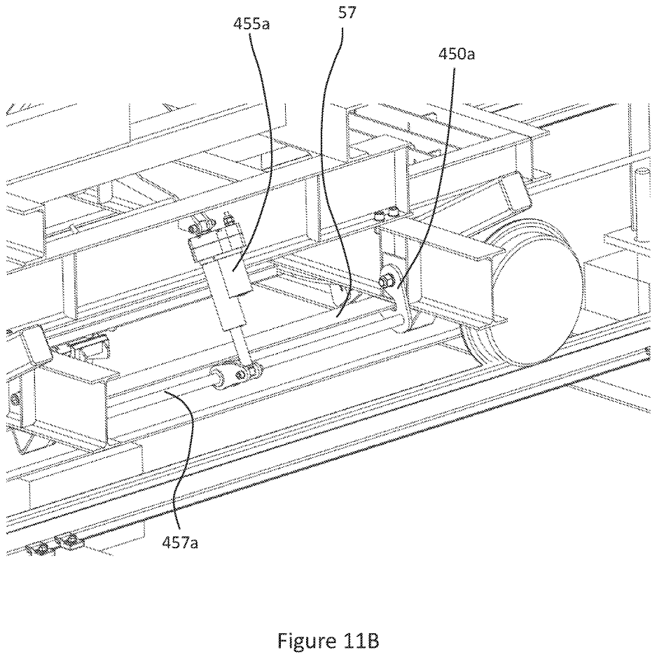

Referring to FIGS. 10, 11A and 11B, the carriage connecting members 425a, 426a each comprises removable locking elements 450a for securing the selected carriage 50 to the scissor lift 410a. In this embodiment, the removable locking elements 450a comprise hooks that are pivotally connected by pivot pins 460a to the carriage connecting members 425a, 426a. The hooks 450a are arranged at each end of the carriage connecting members 425a, 426a so that the selected carriage 50 is secured to the scissor lift 410a at four points approximating each corner of the carriage connecting frame 420a. This ensures that the selected carriage 50 is secured in a stable fashion to the carriage connecting frame 420a. The hooks 450a are operated by linear actuators 455a on either side 427a, 428a to engage a flange or lip 57 of the selected carriage 50. The linear actuators 455a are connected to a pair of hooks 450a on each side 427a, 428a by a common drive shaft 457a. In FIG. 11A, the hooks 450a are in an initial position when the carriage connecting frame 420a engages the selected carriage 50, ready to be actuated. In FIG. 11B, the linear actuators 455a have rotated the hooks 450a about their pivot pins 460a via the common drive shafts 457a to engage the flange 57 of the selected carriage 50.

In other embodiments, the removable locking elements may comprise clamps, latches, electromagnets or other removable fasteners. In addition, there may be a linear actuator 455a for each hook 450a. In further embodiments, different types of actuators may be used, such as a rotary actuator.

Once a selected carriage 50 is deemed necessary to repair or replace, the system 100 is activated to perform removal and replacement of the selected carriage. In this embodiment the maintenance section 55 is connected to the discharge end 25, but it could be equally connected to the loading end 20, where the belt 10 is separated from the carriages 5. The speed of the carriages 5 is then reduced to a maintenance speed that is approximately 5 to 10% of the operational speed of the rail conveyor 1 to enable the selected carriage 50 to be removed and replaced. As the selected carriage 50 passes into the shed 60, the frame assembly 200 moves along the support track 110 so that the transportation assemblies 300a, 300b are in proximity to the selected carriage 50, and are preferably alongside or adjacent the selected carriage. The frame assembly 200 then moves at substantially the same speed at the carriages 5 along the rail track 2; i.e. approximately 5 to 10% of the operational speed of the roller conveyor 1. The speed of the carriages 5 and the frame assembly 200 should be kept relatively slow to enable the transportation assemblies 300a, 300b to remove the selected carriage 50 and insert the replacement carriage 52. It is contemplated that the speed of the carriages 50 and frame assembly 200 should be in the range of 0.1 m/s to 0.6 m/s, preferably 0.3 m/s.

The transportation assemblies 300a, 330b then move along the bridge portion or gantry 210, with the first transportation assembly 300a moving to above the selected carriage 50. The scissor lift 410a is then actuated to lower the carriage connecting member 420a into engagement with the selected carriage 50. The optional channel may be located adjacent to the yoke 8. The hooks 450a are then actuated to pivot and secure the underside of the selected carriage 50 to the carriage connecting frame 420a. Once the selected carriage 50 is secured to the first transportation assembly 300a (as best shown in FIG. 5), the selected carriage is disengaged from the rope 9 to release the selected carriage from its connection to the other carriages 5. The scissor lift 410a is then actuated to raise or lift the selected carriage 50 while moving with the carriages 5, thus safely removing it from the rail track 2. The first transportation assembly 300a then moves along the gantry 210 away from above the rail track 2 to take the selected carriage 50 to a storage location or workstation for repair and/or refurbishment, as best shown in FIG. 8. This allows the second transportation assembly 300b take its place above the rail track 2.

Prior to or shortly after the selected carriage 50 entering the maintenance shed, the second transportation assembly 300b is loaded with the replacement carriage 52 by using the scissor lift 410b to lift the replacement carriage from a storage location using the carriage connecting frame 420b and respective hooks 450b. Once the second transportation assembly 300b is situated above the rail track 2 above the space left behind by the selected carriage 50, the scissor lift 410b lowers the replacement carriage 52 into the space as the remaining carriages 5 move along the rail track 2, as best shown in FIG. 8. The replacement carriage 52 is then connected to the rope 9, and the hooks 450b are actuated to release and the now empty carriage connecting frame 420b is lifted up by the scissor lift 410b. The second transportation assembly 300b then moves along the gantry 210 away from the rail track 2, where it goes to retrieve another replacement carriage 52 for the next replacement operation. The carriages 5, including the replacement carriage 52, then continue on maintenance section 55, exiting the maintenance shed 60 and rejoining the rail conveyor 1 at the discharge end 25 for receiving the conveyor belt 10 for travel along the return run 30 to retrieve another load of bulk material at the loading end 20.

The insertion of the replacement carriage 52 is intended to be performed almost simultaneously with removal of the selected carriage 50. As such, the replacement carriage 52 is lowered into place slightly ahead of the selected carriage 50 being removed. Ideally, this takes place simultaneously if the pitch between the carriages 5 provides sufficient space. As the replacement carriage 52 is supported by the same gantry 210 (via the second transportation assembly 300b) as the selected carriage 50, this ensures that they are travelling at identical speeds. Alternatively, the removal and replacement processes can occur in series if there are space restrictions, as described in more detail below.

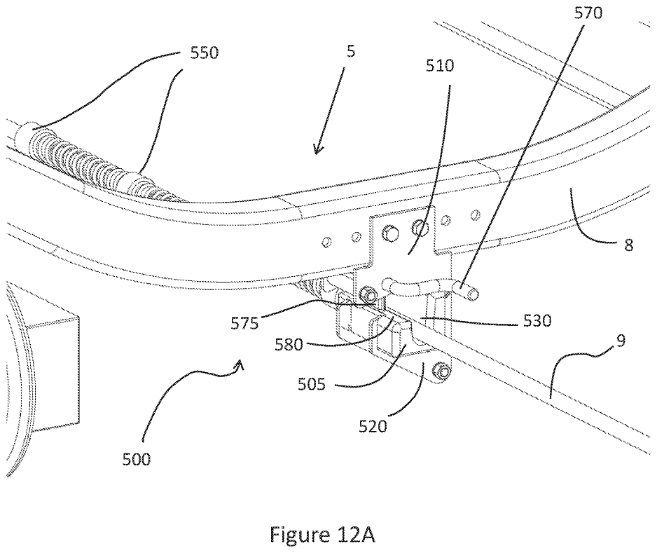

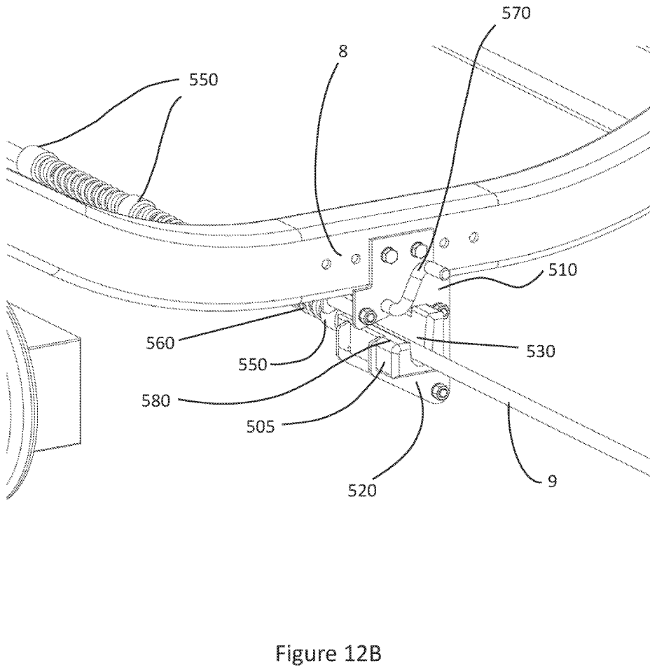

The means by which the selected carriage 50 is disengaged from the rope 9 will now be described below. The connection of the rope 9 to the carriages 5, 50 is shown in FIGS. 12 to 14B, where the carriage 50 has a holding portion in the form of a holding assembly 500 connected to the yoke 8 at one end of the carriage that secures the rope into engagement with the yoke, typically the “front” end in the direction of travel along the rail track 2. The holding assembly 500 may also be called a bush. The holding assembly 500 comprises a body 505 with supporting plates 510, 515 connected to the yoke 8 and a bracket 520. An open channel or sleeve 530 is supported by the bracket 520 and is configured to receive the rope 9. A rear end 540 of the sleeve 530 engages a collar 550 of the rope 9. The collar 550 is biased against the channel end 540 by a compression spring 560 mounted to the rope 9. Other collars 550 may be located on the rope 9. As best shown in FIGS. 12A and 12B, where collars 550 are provided between the compression springs 560 in series. The collars 550 act as guides for the compression spring 560 and as impact buffers when the compression spring contacts the rear end 540 of the sleeve 530. The collars 550 can be made from nylon, or similar material, and act as linear bearing bushes to avoid steel-to-steel contact between the compression springs 560 and the wire rope 9.

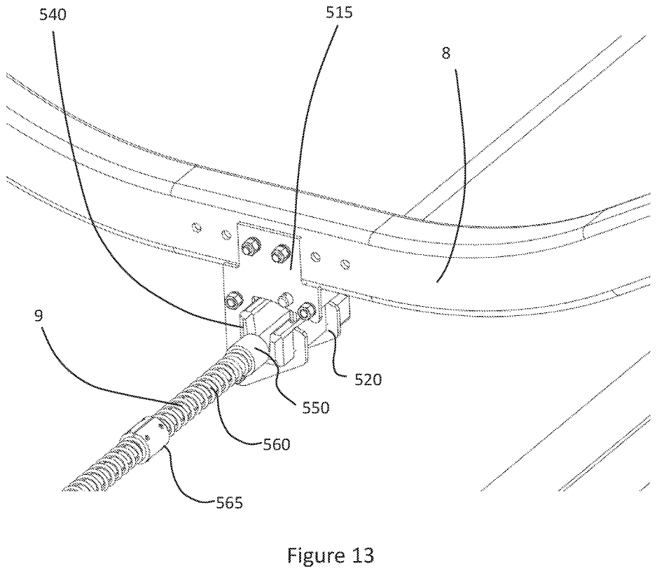

A stop or clamp 565 is used to secure the compression spring 560 and collar 550 to the rope 9, as best shown in FIG. 13. The clamp 565 is located between the collar 550 closest to the holding assembly 500 shown in FIGS. 12A and 12B and the collar 550 at the rear end 540 shown in FIG. 13. The clamp 565 allows the carriages 5 to negotiate through the turnaround loops (when not in contact with the belt) and helps to space the carriages apart. There may be several clamps 565 at set intervals along the rope 9. The clamp 565 may be fixedly held to the rope 9 by way of friction. Alternatively, if the rope 9 is a fibre rope, then the clamp 565 may have a pin or other fastener to prevent axial movement of the clamp relative to the rope 9.

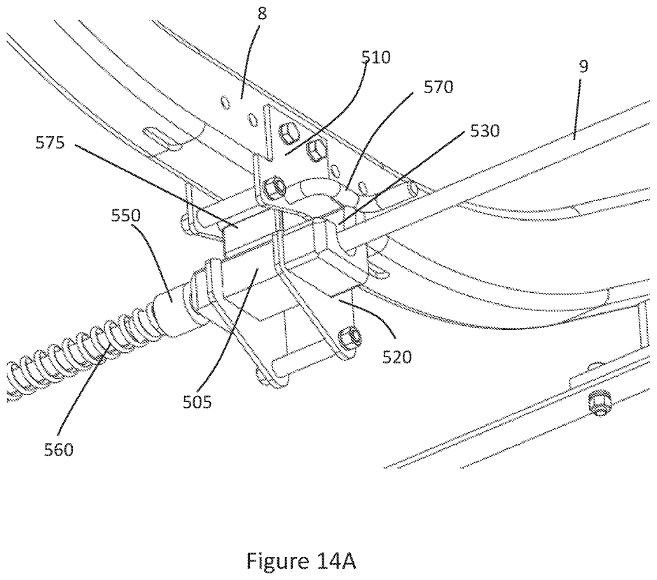

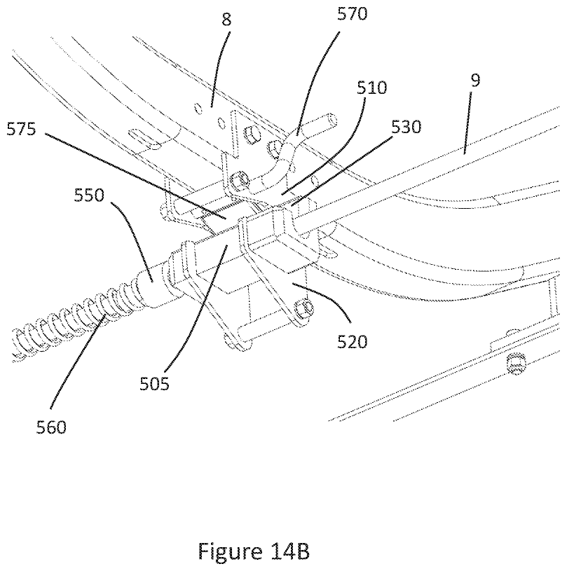

In this arrangement, as the rope 9 is driven forward, the collar 550 engages the rear end 540 of the channel 530 to pull the carriage 5 along the rail track 2 when not engaged with the belt. A rotatable handle 570 is positioned on the supporting plate 510 to act as a quick release mechanism for the rope 9, as best shown in FIGS. 12A and 12B. The rotatable handle 570 connected to a locating latch 575 that moves with rotation of the handle. The latch 575 engages a top surface 580 of the channel 530 to retain the rope 9 within the channel, as best shown in FIG. 14A, and is moved out of engagement to permit the rope to leave the channel, as best shown in FIG. 14B.

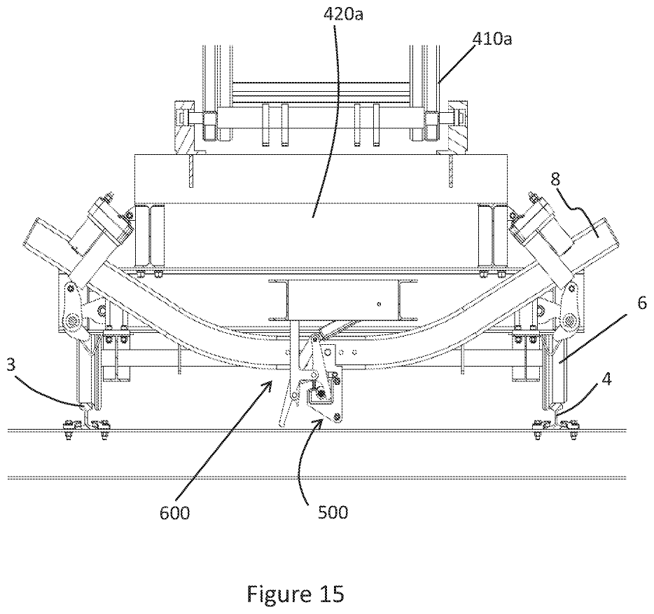

Referring to FIGS. 15 to 21, the transportation assembly 300a has a transfer mechanism 600a configured to detach the rope 9 from the selected carriage 50 in the form of a rope engagement member 610a for engaging the rope 9 and detaching it from the selected carriage 50. In this embodiment, the rope engagement member 610 is pivotally connected to an actuator 620a for moving the rope engagement member into and out of engagement with the rope 9. The actuator 620a comprises an actuator arm 630a connected to a drive member 640a. The rope engagement member 610a is pivotally connected to the actuator arm 630a such that the drive member 640a operates the actuator arm to pivot the rope engagement member. The drive member 640a is in the form of a piston, but in other embodiments make take the form of a linear actuator or the like. The piston 640a may be driven electrically, pneumatically or hydraulically.

The rope engagement member 610a comprises a catch portion 613a for capturing the rope 9 and a transfer arm 615a for moving the rope from the catch portion to a receiving portion 618a. The catch portion 613a is located at a free end of the rope engagement member 610a and the receiving portion 618a is located at the opposite end of the rope engagement member. In other embodiments, the catch portion 613a and the receiving portion 618a may be located in proximity to opposed ends of the rope engagement member 610a.

A support arm 645a connects the transfer mechanism 600a to the conveyor mechanism 400a, and in this embodiment the rope engagement member 610a is pivotally connected to the support arm 645a. A pivot member 650a moves rotatable handle 570 and the locating latch 575 to enable the rope 9 to be removed from the channel 530. This also provides a clearance space for the rope engagement member 610a to engage and detach the rope 9 from the selected carriage 50. The pivot member 650a is pivotally connected to both the support arm 645a and the actuator arm 630a.

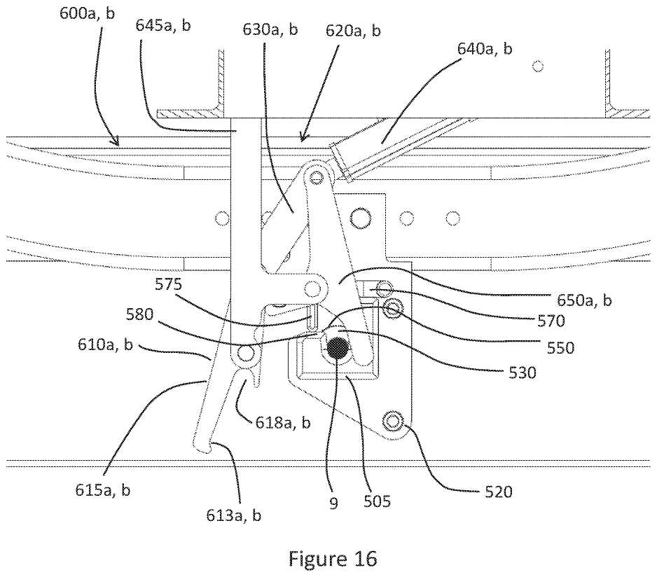

Referring to FIG. 10 and FIGS. 15 to 21, the sequence in which the transfer mechanism 600a engages the rope 9 and disengage it from the selected carriage 50 is shown. In FIG. 10, the carriage engagement frame 420a descends to engage the selected carriage 50 and the hooks 450a are actuated to secure the selected carriage to the carriage engagement frame. Referring to FIGS. 15 and 16, the locating latch 575 is in engagement or contact with the top surface 580 of the channel 530. The transfer mechanism 600a is in position at or in proximity to the holding assembly 500, ready to be activated to disengage the selected carriage 50 from the rope 9 so that it is free to be removed from the rail track 2.

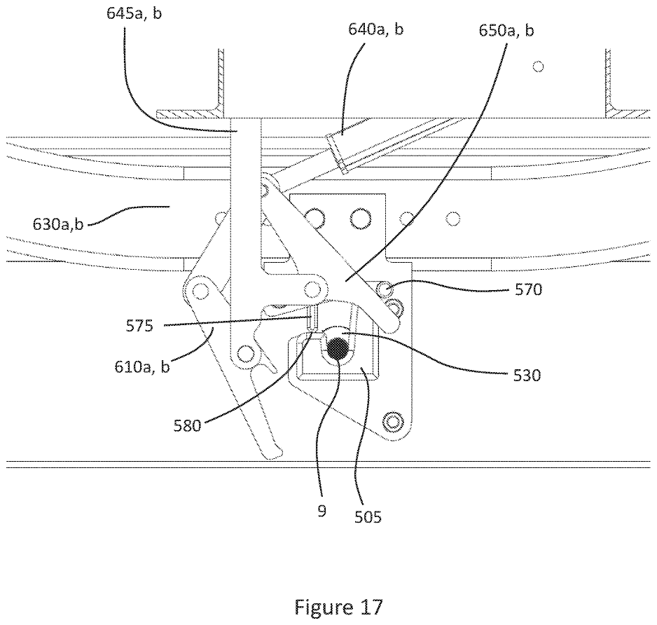

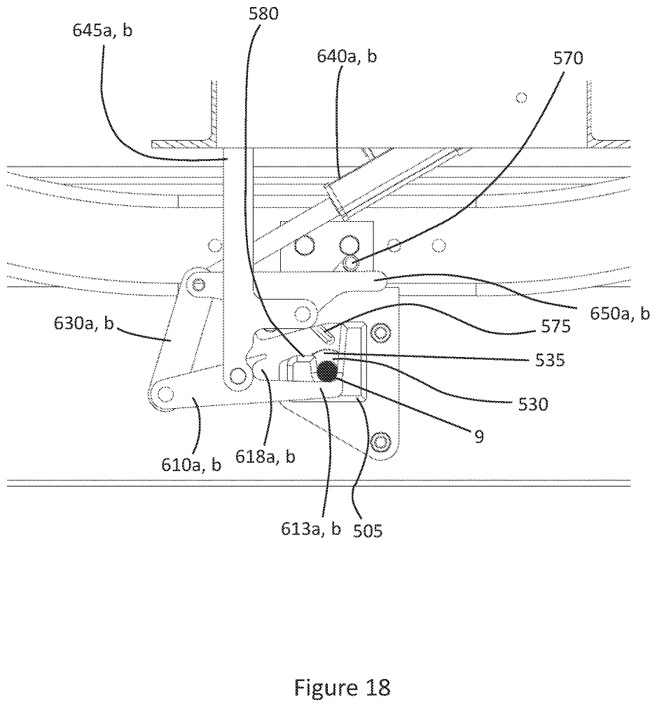

Referring to FIG. 17, The piston 640a drives the actuator arm 630a, which causes the rope engagement member 610a to pivot so that its catch portion 613a rotates or pivots towards the rope 9. At the same time, the pivot member 650a also pivots about the support arm 645a to contact the handle 570 of the selected carriage 50. At best shown in FIG. 18, the actuator arm 630a continues to pivot the rope engagement member 610a, causing the catch portion 613a to engage or grasp the rope 9. At the same time, the pivot member 650a has moved the handle 570 out of the area surrounding the holding assembly 500, including a top opening 535 of the channel 530. The rotation of the handle 570 also pivots the locating latch 575 out of engagement with the top surface 580 and away from the channel 530.

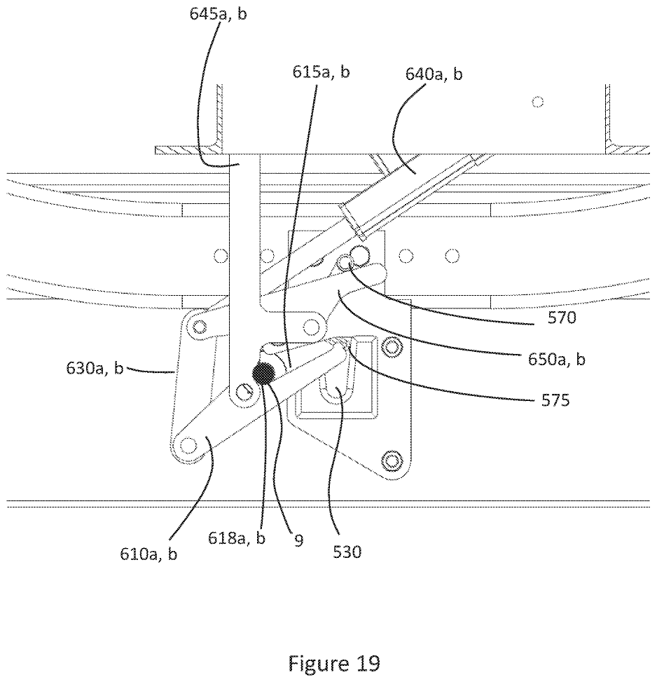

Referring to FIG. 19, the actuator arm 630a continues to pivot the rope engagement member 610a so that the catch portion 613a lifts the rope 9 out of the channel 530 so that it slides down the transfer arm 615a and into the receiving portion 618a. Since the pivot member 650a has moved the handle 570 (and thus the locating latch 575) out of the vicinity of the channel 530, as best show in FIG. 14B. This has created a clearance space above the top opening 535 of the channel to enable the rope 9 to move unhindered along the transfer arm 615a into the receiving portion 618a. If required, a secondary piston driven electrically, pneumatically or hydraulically may also be incorporated into the transfer mechanism 600a, preferably operatively connected to the transfer arm 615a, to push and hold the rope 9 into the receiving portion of 618a.

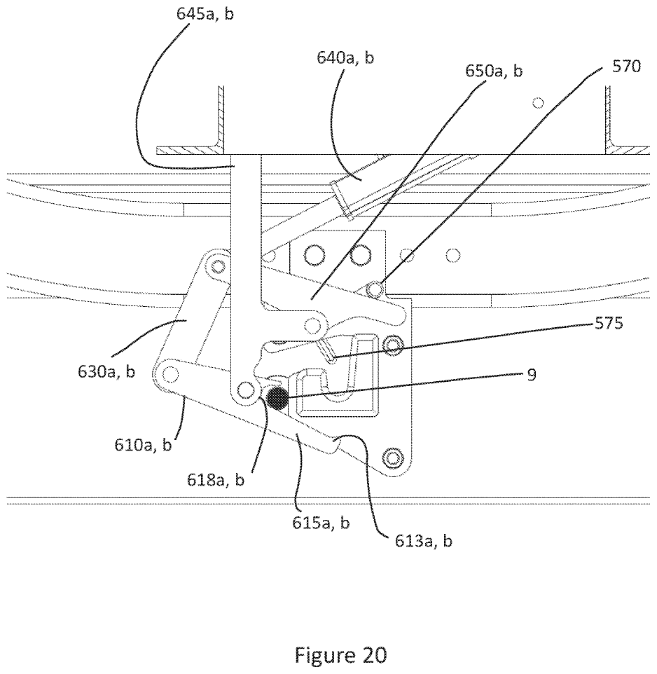

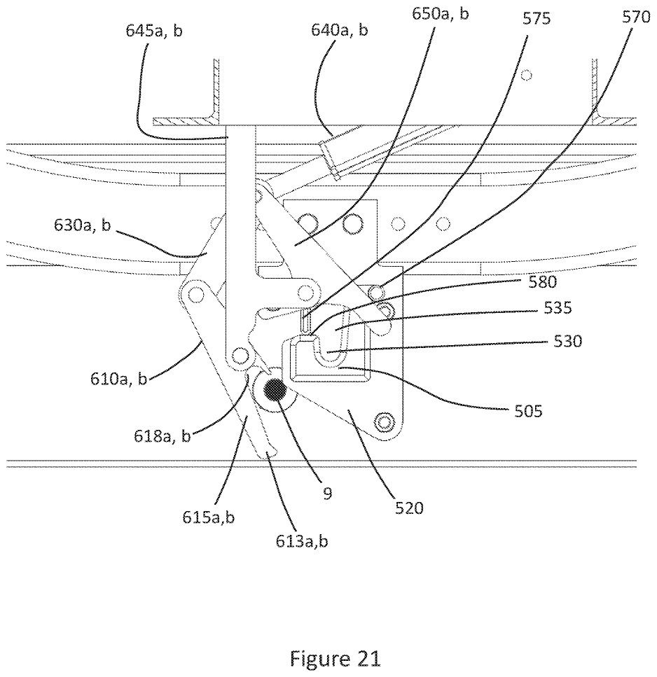

Referring to FIG. 20, the piston 640a has finished its stroke and begins to retract, reversing the movement of the actuator arm 630 so that it moves upward. This causes the rope engagement member 610a to pivot so that the rope 9 is released from the receiving portion 618a to move back along the transfer arm 615a. If required, the secondary piston discussed above would move the rope 9 along the transfer arm 615a. At this point of release, the rope 9 is now displaced away from the channel 530 and top opening 535 and so cannot accidentally fall back into the channel. As best shown in FIG. 21, the actuator arm 630 continues to move, by which time the rope engagement member 610a has continued to pivot until the rope 9 is fully released from the transfer arm 615a, detaching the rope from the holding assembly 500 of the selected carriage 50. At the same time, the pivot member 650a has returned to its original position, causing the handle 570 (and locating latch 575) to rest in the closed position, as best shown in FIG. 14A. The selected carriage 50 is now free to be removed from the rail track 2 by the scissor lift 410a without being engaged to the rope 9 connecting the selected carriage to the other carriages 5.

As the first transportation assembly 300a is the same as the second transportation assembly 330b, it will be appreciated by those skilled in the art that the steps for attaching the replacement carriage 52 to the rope 9 and hence to the carriages 5 on the rail track 2 will be the reverse of the steps for removing the selected carriage 50 as described above, except that the second transportation assembly 300b will perform these steps using the conveyor mechanism 400b and transfer mechanism 600b. In summary, as best shown in FIG. 21, the replacement carriage 52 has been lowered onto the rail track 2 by the lift mechanism 410b. The transfer mechanism 600b is in the correct position to attach the rope 9 to the replacement carriage. In this case, the actuator 620b extends the piston 640b and the actuator arm 630b pivots the rope engagement member 610b to engage the rope 9 via the transfer arm 615b (as best shown in FIG. 20). If required, the secondary piston mentioned above moves the rope 9 along the transfer arm 615a. Continual movement of the actuator arm 630b pivots the rope engagement member 610b to move the rope 9 into the receiving portion 618b (as best shown in FIG. 19), then back along the transfer arm to the catch portion 613b (as best shown in FIG. 18) and finally from the catch portion 613b into the channel 530 (as best shown in FIGS. 16 and 17). Again, if required, the secondary piston moves the rope 9 along the transfer arm 615a to the catch portion 613b and finally from the catch portion 613b into the channel 530. The rope 9 is thus securely held in the channel 530, connecting the replacement carriage 52 to the rope 9 via the holding assembly 500 and thus the other carriages 5 in the rail conveyor 1. The hooks 450b are then pivoted to release the replacement carriage 52 from the carriage engagement frame 420b. The replacement carriage 52 will then slow down and rest against the spring collar 550.

It can thus be seen that the embodiments of the invention reduce the time and labour in performing maintenance, and improves worker safety. As the removal and replacement of the selected carriage 50 can be performed remotely, there is no need for electrically isolation of the rail conveyor 1 to protect workers as they can be safely located away from hazards around the rail conveyor. The frame assembly 200 and transportation assemblies 300a, 300b reduces the amount of labour and time in performing these maintenance tasks, thus reducing costs and improving efficiency of the rail conveyor 1. In addition, the embodiments of the invention can equally be used for installation of the carriages onto the rail conveyor system. In contrast, the current prior art solution for carriage removal and replacement is manual and requires the entire system to be stopped and isolated, taking an estimated 30 to 40 minutes per carriage for a 3 km long system and greater for longer rail track systems.

Due to the necessity to match the speeds of the frame assembly 200 and the carriages 5, the system 100 is designed to be automated. While it is conceivable that the system 100 could be manually operated, it is clearly preferable to use automation.

Accordingly, the frame assembly 200 and transportation assemblies 300a, 300b are in electronic communication with a controller (not shown), wherein the controller sends signals to the frame assembly and transportation assemblies to control movement of the frame assembly and operation of the transportation assembly. The controller may communicate electronically with the frame assembly 20 and transportation assemblies 300a, 300b either wired or wirelessly, including LAN, WAN, Bluetooth, NFC and other wireless forms of electronic communication. The controller is also preferably in electronic communication with the conveyor mechanisms 400a, 400b and the transfer mechanisms 600a, 600b.

The controller may comprise a computer, programmable logic controller (PLC) or central processing unit (CPU) to automate operation of the system 100 and control the frame assembly 200, transportation assemblies 300a, 300b, conveyor mechanisms 400a, 400b and the transfer mechanisms 600a, 600b.

The controller may also be used to determine when a carriage 5 requires replacement and/or repair. Accordingly, the controller will be in electronic communication with various sensors associated with each carriage 5 to monitor the bearings and wheels and detect for signs of damage, wear and failure. Each carriage 5 may also be individually identifiable and tracked using RFID, or a similar, tracking technology.

The primary advantage in automating the system 100 is that it reduces or eliminates downtime for the rail conveyor 1 as the carriages 5 may be replaced in situ as the carriages move through the maintenance section 55 of the rail track 2 without significant interruption (the only constraint being the reduction in the conveyor speed during removal and replacement).

However, if it is desired to permit manual operation, the system 100 can be adapted so that it can operate in a “manual” mode, where the frame assembly 200 does not move with the carriages 5 as they travel along the maintenance section 55. Instead, the rail conveyor 1 would be stopped so that the carriages 5 are stationary to permit the selected carriage 50 to be removed and replaced on the rail track 2. The frame assembly 200 would be actuated by an operator using a remote control to move transportation assemblies 300a, 330b into position above the selected carriage 50 for its removal and replacement. Similarly, the conveyor mechanisms 400a, 400b and transfer mechanisms 600a, 600b would be manually operated via remote control. While this modification does create downtime for the rail conveyor 1, there are still advantages in safety, labour and time, as the rail conveyor 1 would not need to be electrically isolated because there are not any workers required to physically interact with the rail conveyor, less overall downtime than the prior art and less labour required.

In yet further embodiments, parts of the system 100 may be manually operated and other parts automated. For example, the frame assembly 200 may be manually operated, but the transportation assemblies 300a, 330b, and their associated conveyor mechanisms 400a, 400b and transfer mechanisms 600a, 600b may be automated as described above, or any combination of manual and automated control may be used for parts of the system 100.

In other embodiments, there may be a plurality of transportation assemblies 300 that may be grouped in pairs or more to enable removal and replacement of multiple carriages at the same time. In further embodiments, the system 100 may employ a single transportation assembly 300 to perform both removal and replacement functions, although this would require a longer support track 110 to provide sufficient time for the same transportation assembly 300 to remove the selected carriage 50, deposit it at a repair station, pick up a replacement carriage 52 and insert it back into the carriages 5.

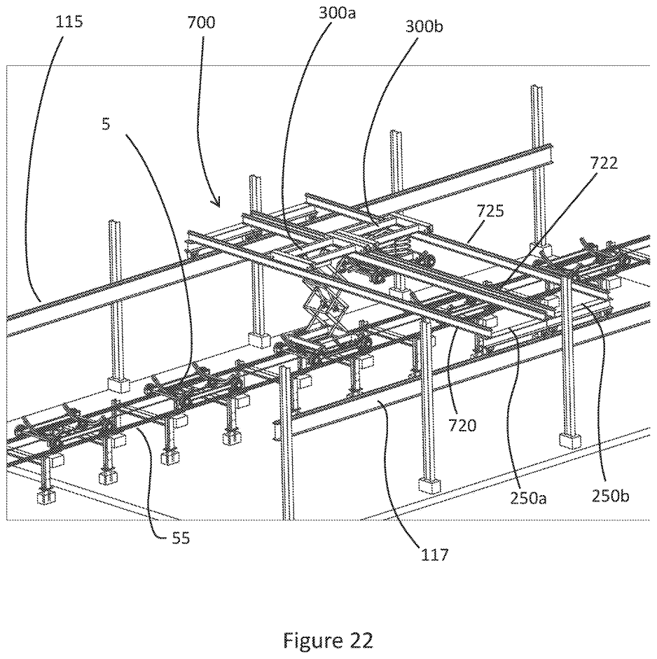

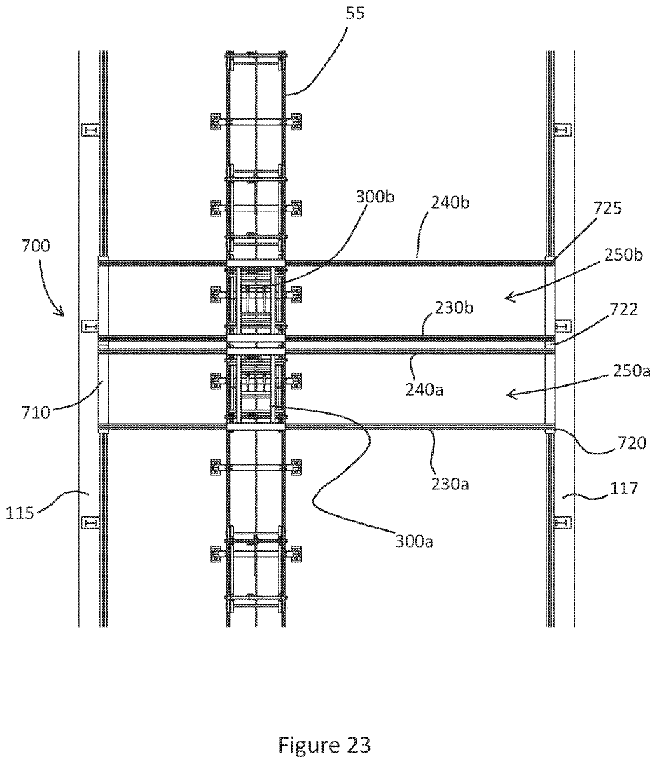

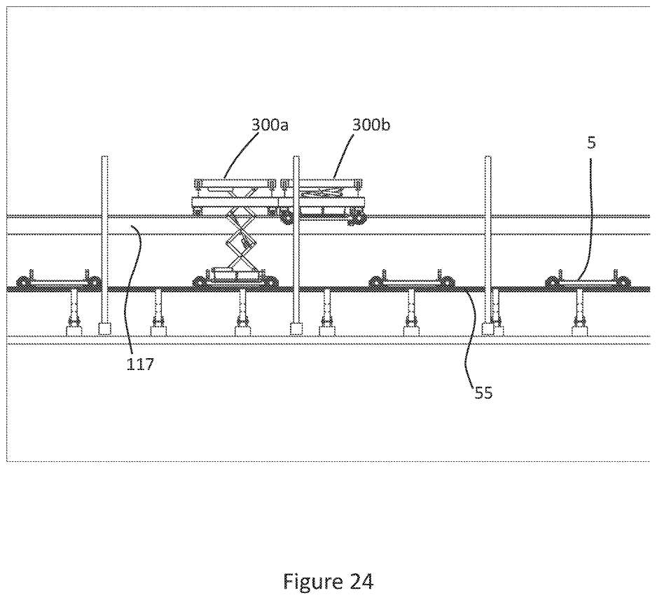

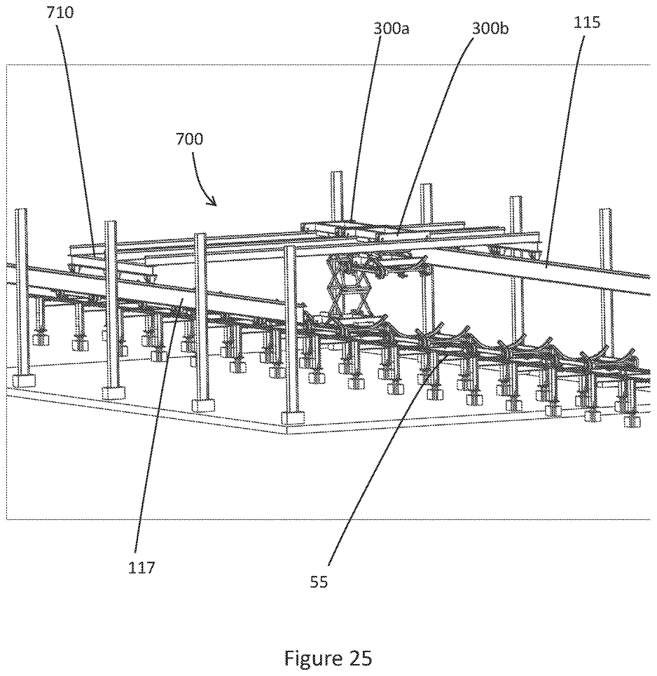

Referring to FIGS. 22 to 25, a further embodiment of the invention is shown where there are two transportation assemblies 300a, 300b arranged in an in line configuration (or parallel) and mounted on a frame assembly 700 having separate bridge tracks 250a, 250 for each respective transportation assembly. In this case, the bridge section or gantry 710 has three beam members 720, 722, 725 that define the two bridge tracks 250a, 250b with their respective rails 230a, 240a and 230b, 240b, where the rails 240a and 230b are on the same beam member 722. This allows the transportation assemblies 300a, 300b to move independently of each other on their respective bridge tracks 250a, 250b, while permitting a reduction in the width of the maintenance shed 60. This also allows a refurbished carriage 52 to be lowered into the space between consecutive carriages 5 as the selected carriage 50 is being removed. That is, this arrangement allows both the removal and replacement process to occur at the same time.

Furthermore, in other embodiments, different types of lifting mechanisms can be used for the conveyor mechanism 400a, 400b. For example, a hoist or crane could be used instead of a scissor lift 410a to remove and replace the selected carriage 50. Other lifting mechanisms can include a telescopic arm or telescopic crane. However, it is preferred to use a scissor lift 410a as it is more stable and thus avoids having to compensate for sway that would be induced in the hoist or crane rope by movement of the hoist or crane along the gantry 210.

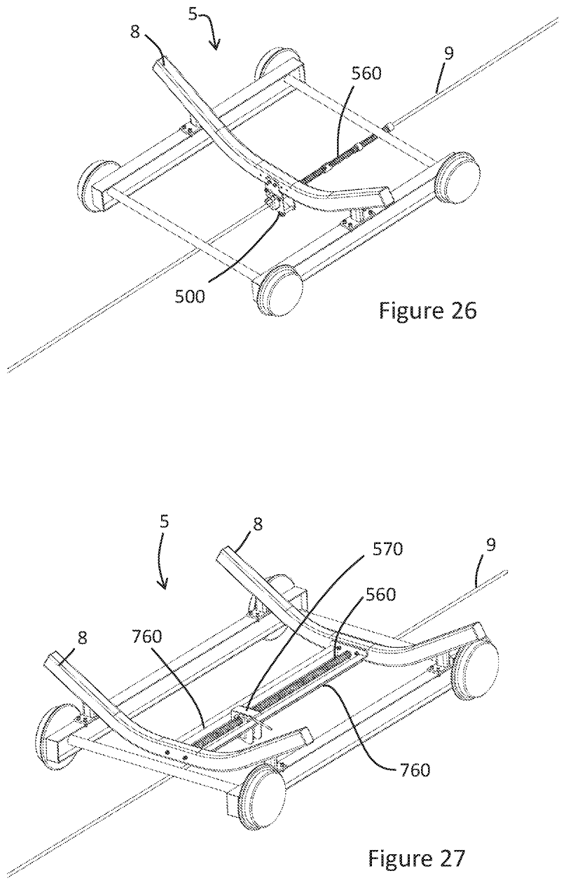

The previous embodiments of the invention have been described with reference to a carriage 5 with two yokes 8. In other embodiments, the carriages may have a single yoke 8, as best shown in FIG. 26. In this case, the position of the transfer mechanism 600a, 600b is adjusted to correspond to the location of the yoke 8 and the holding assembly 500. In these embodiments, a compression spring 560 is mounted to the rope 9. The clamp 565 is fixed to the rope 9, with a compression spring 560 on either side of the clamp, and the collar 550 is fixed to the end of the compression spring that slides relative to the rope. In an alternative embodiment, the collar 550 is connected or is attached to the holding assembly 500. Alternatively in another embodiment the rope 9 can be directly coupled to the holding assembly 500.

In an alternative embodiment shown in FIGS. 27 to 29, a compression spring 560 is effectively fitted to the carriage 5 by placing two compression springs on either side of the holding assembly 500 that are between two support beams 760. This arrangement is more convenient as it frees the rope 9 from the collar 550 and compression spring 560 and provides more tolerance in inserting the replacement carriages 50 as there is no need to ensure that the holding assembly 500 of the replacement carriage is positioned so it can engage the compression spring 560 on the rope 9. This arrangement also results in less wear of the rope 9 due to the holding assembly 560 sliding on the rope, enables easy replacement of damaged springs 560, easy replacement of the rope and eliminating the need for the collar 550 to be fixed to the rope 9. In other embodiments, clamps 565 may be provided on both sides of the holding assembly 500 to prevent movement of the holding assembly relative to the rope 9. Alternatively, in a further embodiment, the rope 9 can be directly coupled to the holding assembly 500, again removing the need for the clamp 565.

In other embodiments, two or more sliding bearings or bush arrangements are used to support the holding assembly 500 without the need for the support beams 760. In a further embodiment, the support beams 760 may take the form of tubular beams, rods or pipe-like beams to guide the movement of the holding assembly. In either case, the support beams or support rods should have sufficient strength to resist or support the loading forces on the holding assembly 500 caused by the movement of the rope 9, especially when the carriages 5 move along horizontal curved portions and the turnaround portions of the rail track 2.

A tension spring may in other embodiments be used instead of the compression spring 560. Also, a dampening element (not shown) may be used in conjunction with the tension spring or compression spring 560. In other embodiments, there may be multiple tension springs or compression springs 560 arranged in either series or parallel. The parallel arrangement may be provided in particular for the embodiments where the compression springs 560 are mounted to the carriage 5.

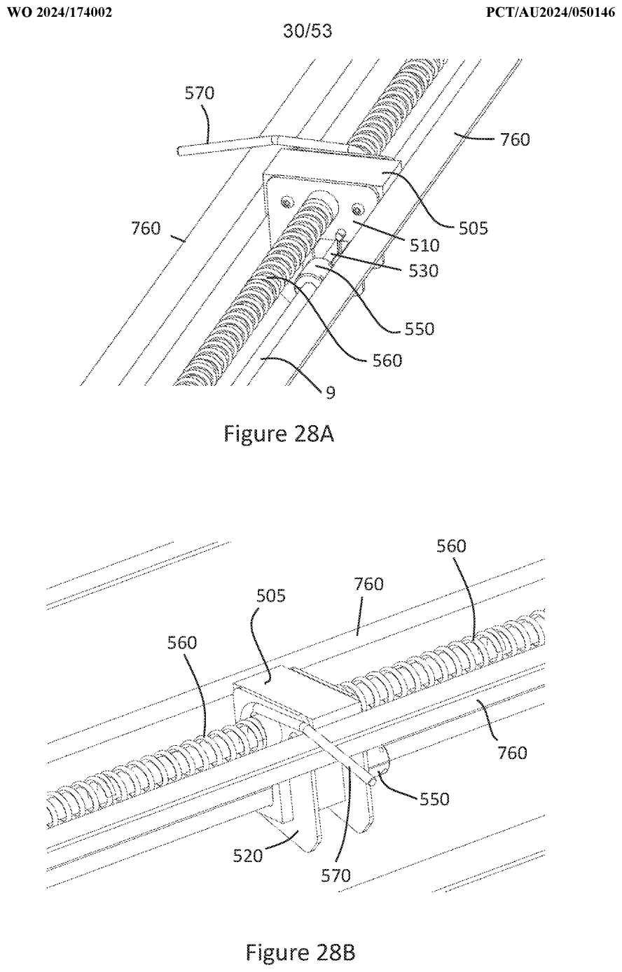

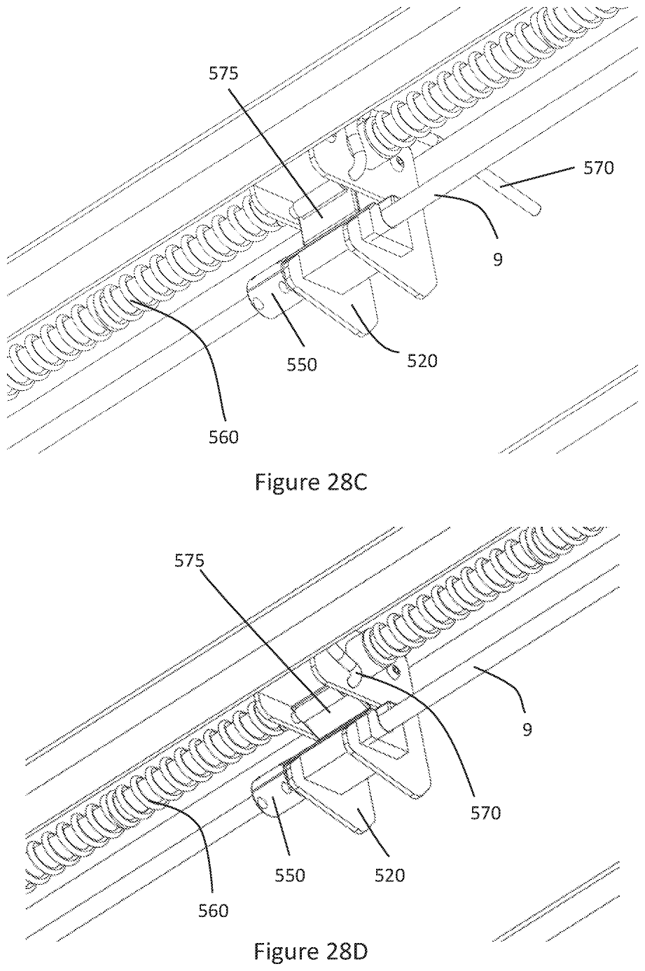

As best shown in FIGS. 28A and 28B, the holding assembly 500 has a body 505 connected to the supporting plates 510, 515 and is able to slidingly move between the support beams 760. Thus, the holding assembly or bush 500 is able to move between the yokes 8 of the carriages 50 within the support beams 760, but this movement can be limited by the compression spring 560 on either side of the holding assembly body 505. There may be provided a rod (not shown) to support the holding assembly 500 that the compression springs 560 are placed over. The rotatable handle 570 is still positioned on the supporting plate 510 to act as a quick release mechanism for the rope 9, and moves the locating latch 575 between the closed open positions, as best shown in FIGS. 28C and 28D, just like the earlier embodiments. The handle 570 extends over the channel 530 and past the support beam 760 to retain the rope 9 within the channel using its own weight.

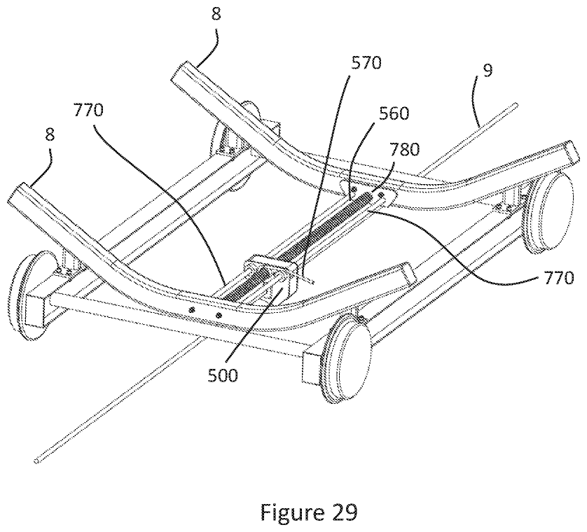

FIG. 29 illustrates a further variation to the carriage 5, where the support beams 760 of FIGS. 27 to 28D have been replaced with tubular beams, rods or pipe-like beams 770 to act as guides for the movement of the holding assembly 500. The arrangement is similar to the embodiment of FIGS. 27 to 28B, with the holding assembly 500 body being mounted to the tubular guides 770 and can freely move or slide between the two yokes 8 of the carriage 5. The tubular guides 770 are mounted to end plates 780 to the yokes 8. The tubular guides 770 may thus essentially form a track for movement of the holding assembly 500. One of the tubular guides 770 (being the middle guide) receives the compression springs 560 on either side of the holding assembly 500. The handle 570 also extends over the channel 530 and past one tubular guide 770 to retain the rope 9 within the channel. This arrangement has the same technical advantages and load resistance as the arrangement of FIGS. 27 to 28D described above.

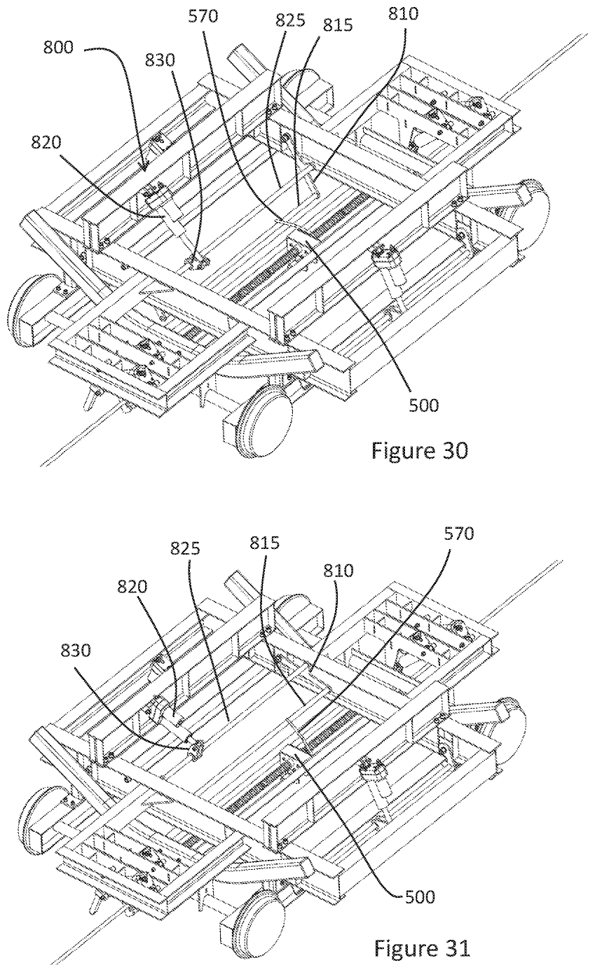

Since the holding assembly 500 can now move along the support beams 760 between the two yokes 8, a transfer assembly 800 is provided to engage the handle 570 irrespective of where it (and the bush 500) is located between the yokes 8. The transfer assembly 800 is connected to the carriage connecting frame 420a, 420b of the conveyor mechanism 400a, 400b. Referring to FIGS. 30 to 35, the transfer assembly 800 comprises a transfer arm 810 operably connected to a transfer rod 815 such that the transfer arm moves the transfer rod to engage and move the handle 570. In this embodiment, there is pair of transfer arms 810 at either end of the transfer rod 815, but in other embodiments, a single transfer arm 810 may be used.

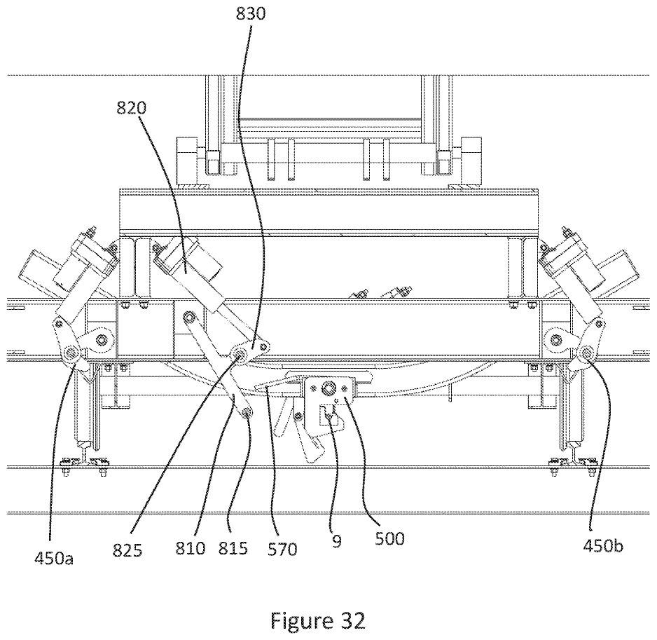

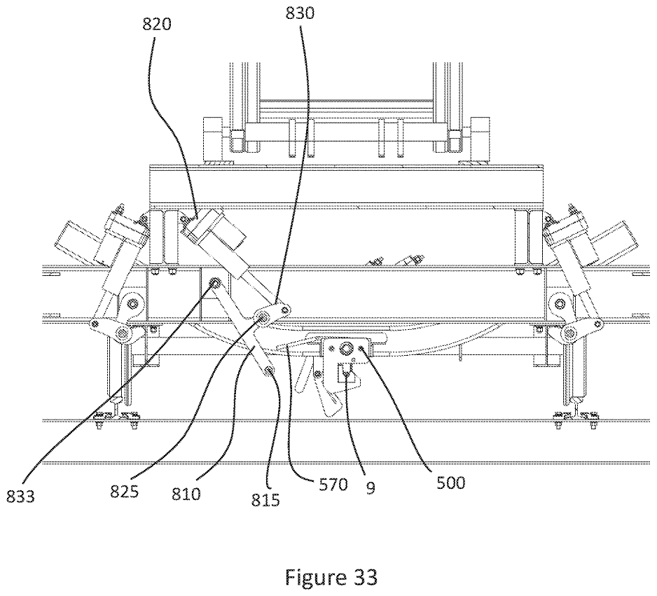

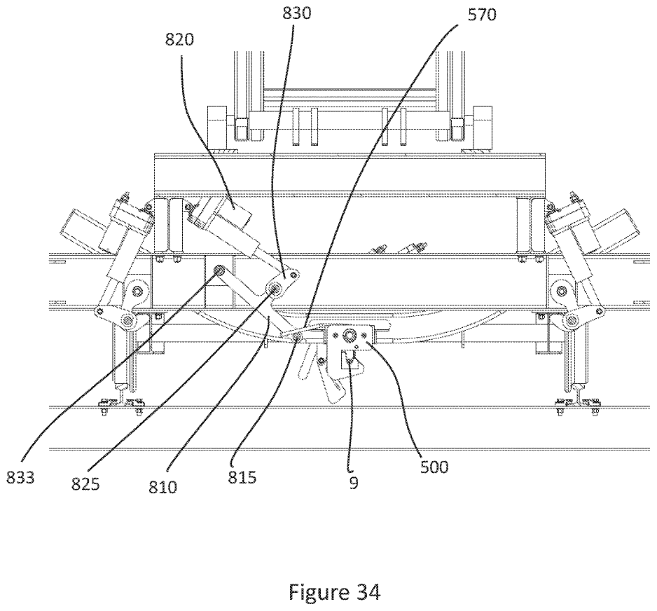

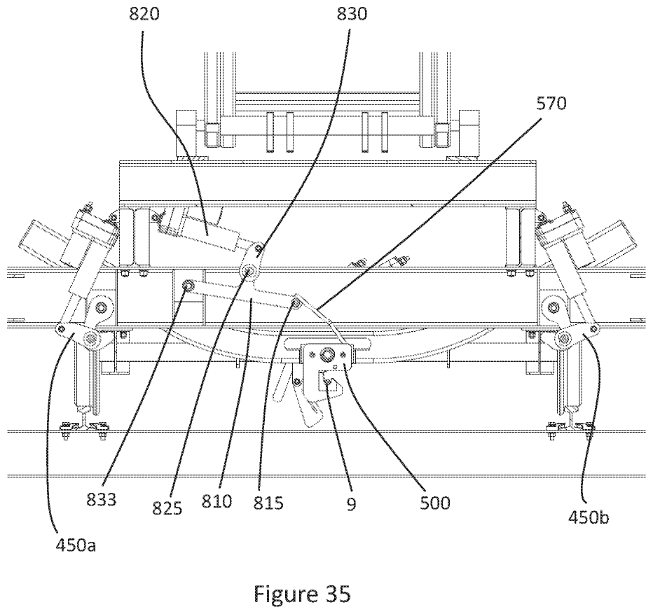

The transfer assembly has an actuator 820 that is connected an actuator rod 825, which is pivotally connected to the transfer arm 810. The actuator 820 also has an actuator arm 830 pivotally connected to the actuator rod 825. In operation, from a closed position of the handle 570 shown in FIGS. 30 and 32 (and the latch 575 shown in FIG. 28C), the actuator 820 drives the actuator arm 830 to move the actuator rod 825. This causes the transfer arm 810 to pivot or rotate about a pivot pin 833, as best shown in FIG. 33. This causes the transfer rod 815 to move into engagement with the handle 570, as best shown in FIG. 34. The transfer rod 815 continues to move, causing the handle 570 to move out of its position over the channel 530 and the support beam 670, as best shown in FIG. 35. The latch 575 also moves out of engagement covering the channel 530, as best shown in FIG. 28D. The handle 570 and latch 575 are thus moved into an open position so that the rope 9 can be moved out of the channel 530 of the holding assembly 500, as best shown in FIG. 31. While this embodiment uses a variety of pivotal connections between the transfer arm 810, transfer rod 815, actuator rod 825 and actuator arm 830, it will be appreciated that other linkage arrangements may be used to move the transfer rod into and out of engagement with the handle 570.

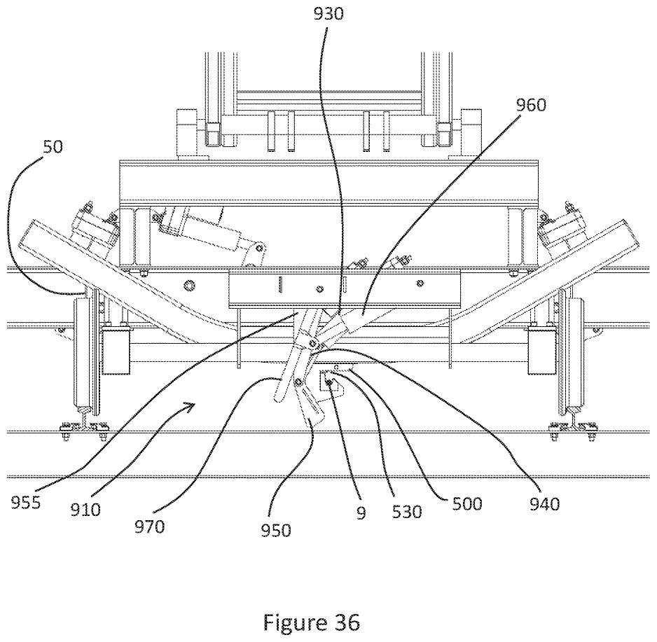

Referring to FIGS. 36 to 48, an alternative embodiment of the transfer mechanism is shown, that is primarily intended for use with the carriage 5 of FIGS. 27 to 29. The transfer mechanism is divided into a rope removal mechanism 910 and a rope placement mechanism 920. Referring to FIG. 36, the rope removal mechanism 910 comprises a first actuator 930 having an actuator arm 940 pivotally connected to a first rope engagement member 950 such that the actuator arm pivots the first rope engagement member to displace the rope 9 from the selected carriage 50. A secondary support arm 955 is pivotally connected to the first rope engagement member 950. The rope removal mechanism 910 also comprises a transfer actuator 960 operably connected to a transfer arm 970 to remove the rope 9 from the first rope engagement member 950, thereby detaching the rope from the selected carriage 50. When inactive, the transfer arm 970 is located in an extended position away from the holding assembly 500.

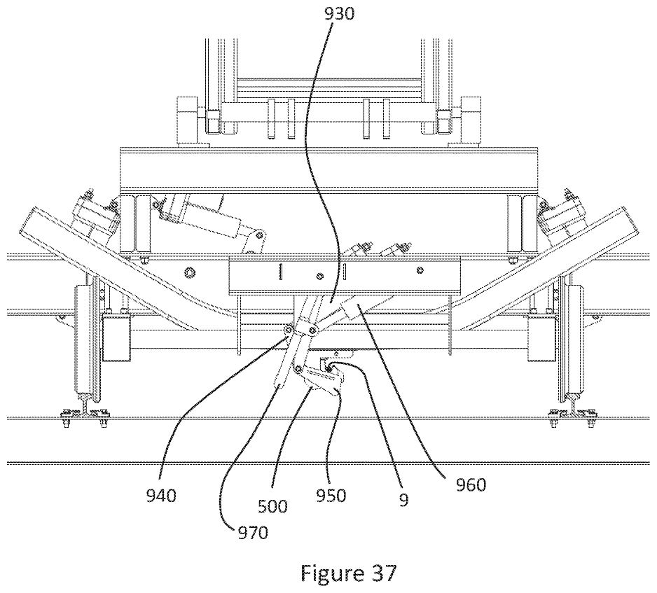

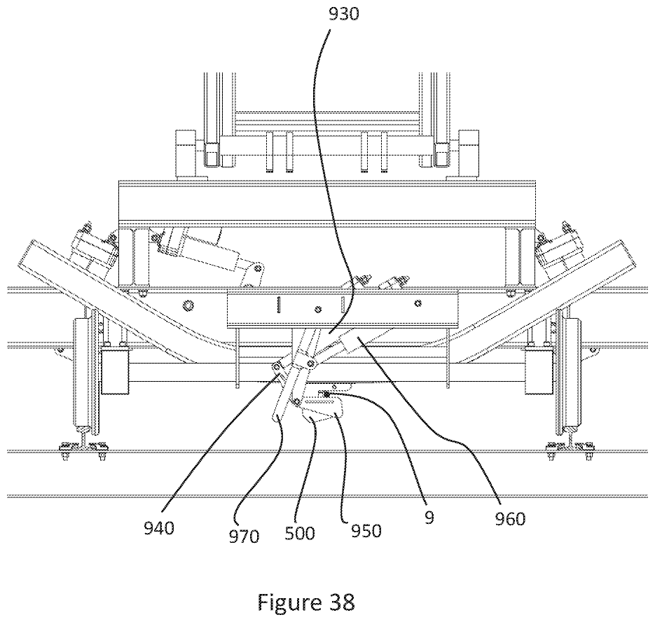

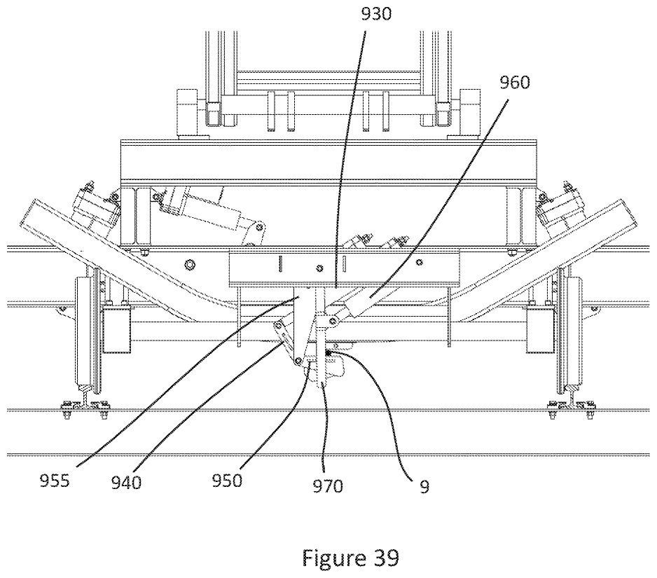

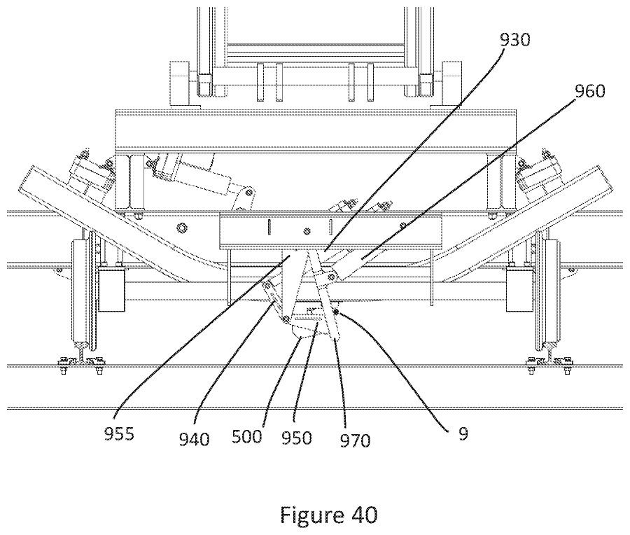

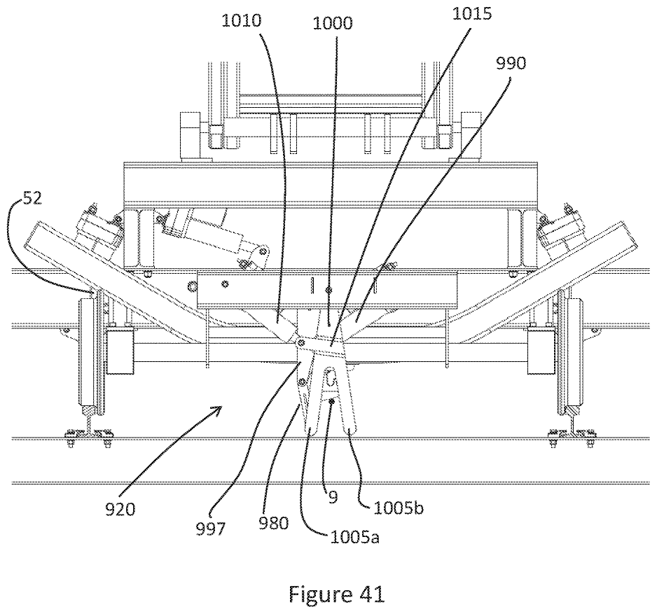

In operation, the actuator 930 drives the actuator arm 940, causing the rope engagement member 950 to pivot upwards into engagement with the rope 9, as best shown in FIG. 37. The first rope engagement member 950 then lifts the rope 9 out of the channel 530 of the holding assembly 500, as best shown in FIG. 38. The transfer actuator 960 then moves the transfer arm 970 in a swinging or sweeping motion across the first rope engagement member 950, also best shown in FIG. 38. The transfer arm 970 then engages the rope 9 held by the first rope engagement member 950 and moves it along the edge of the first rope engagement member 950, as best shown in FIG. 39. The transfer arm 970 continues to move the rope 9 until it is removed from the first rope engagement member 950, as best shown in FIG. 40. The first rope engagement member 950 and the transfer arm 970 return to their original positions, as shown in FIG. 36. The rope 9 is then allowed to move to a rest position as determined by its tension, as best shown in FIG. 41.

Referring to FIG. 41, the rope placement mechanism 920 comprises a second rope engagement member 980 for engaging the rope 9 and attaching the rope to the replacement carriage 52. The second rope engagement member 980 is connected to a second actuator 990, preferably via a pivotal link 995 and support arm 997, for moving the rope engagement member into and out of engagement with the rope 9. The rope placement mechanism 920 also comprises a rope guide 1000 for guiding movement of the rope 9, preferably in the form of a yoke or having a Y-shape, with two arms 1005a, 1005b. It will be appreciated that the rope guide 1000 in other embodiments may take different forms or shapes and is not limited to the Y-shape shown in the Figures. Generally, it is preferable that the rope guide 1000 has at least two arms to provide the guiding movement for the rope 9 as discussed below.

A rope guide actuator 1010 is preferably pivotally connected to a rope guide arm 1015 to move the rope guide 1000. The rope guide 1000 is movable to guide the rope 9 into engagement with the second rope engagement member 980. The rope guide 1000 is also able to move the rope relative to the second rope engagement member 980 such that the second rope engagement member is able to release the rope 9 into the channel 530 of the holding assembly 500 of the replacement carriage 52, thereby attaching the rope to the replacement carriage 52.

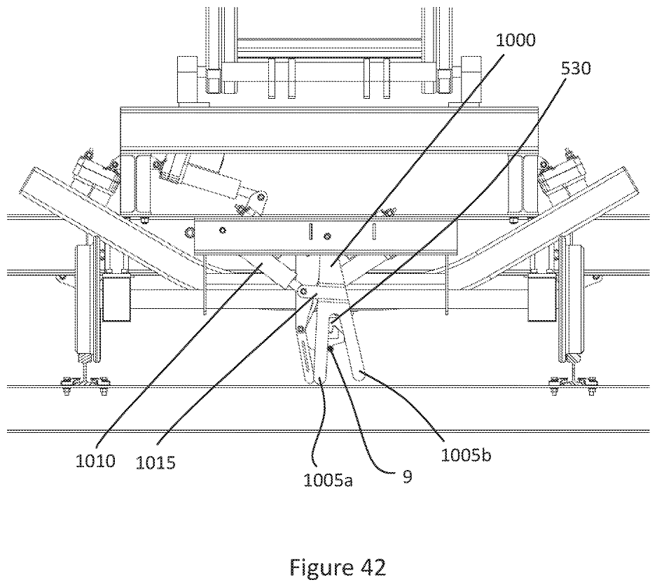

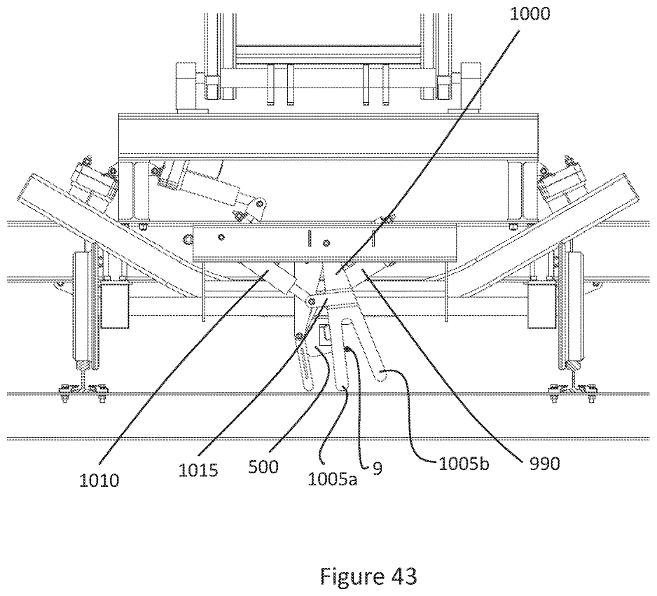

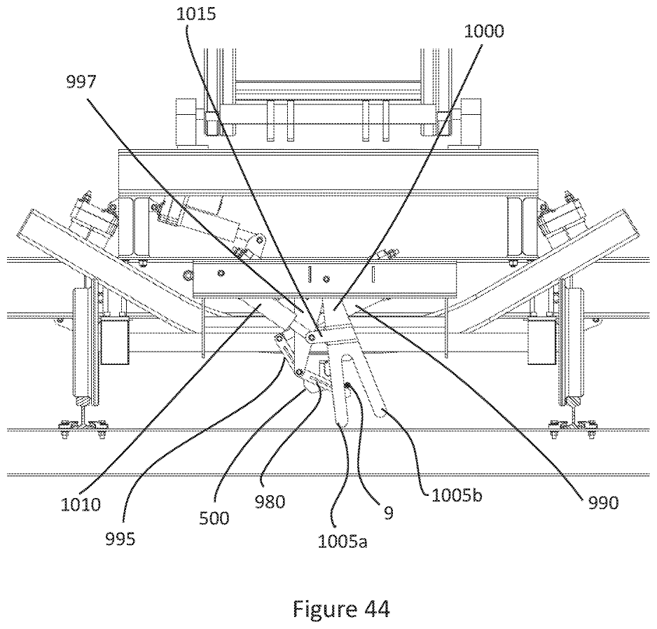

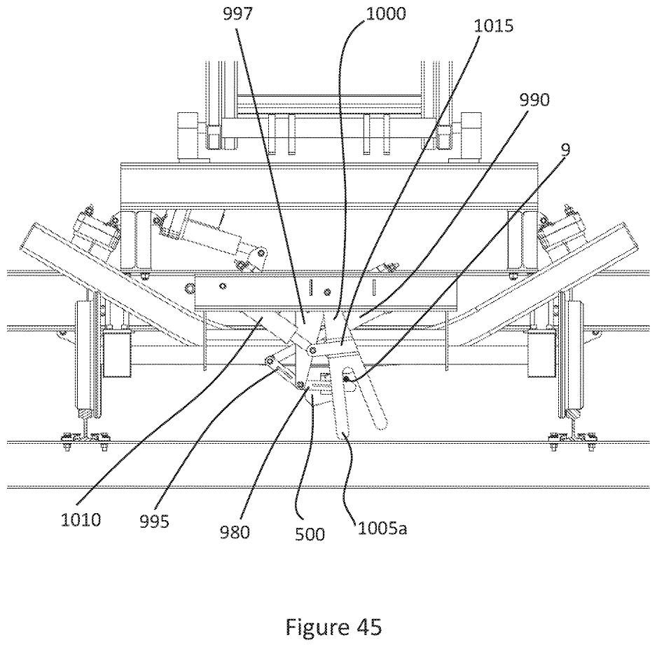

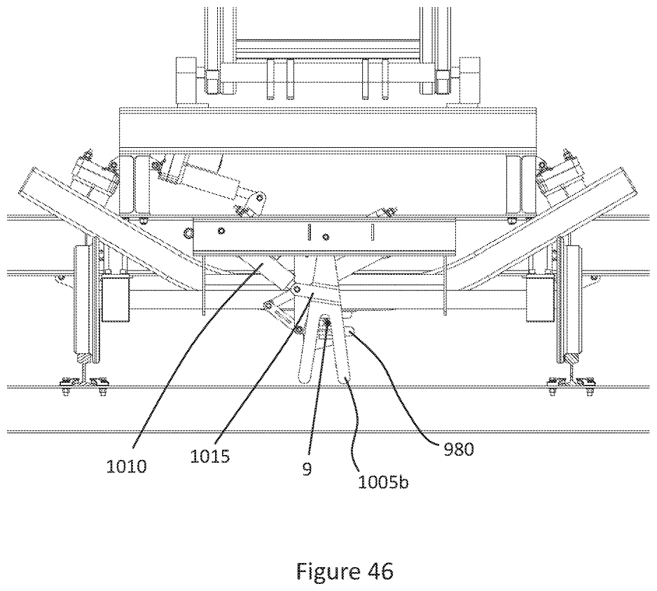

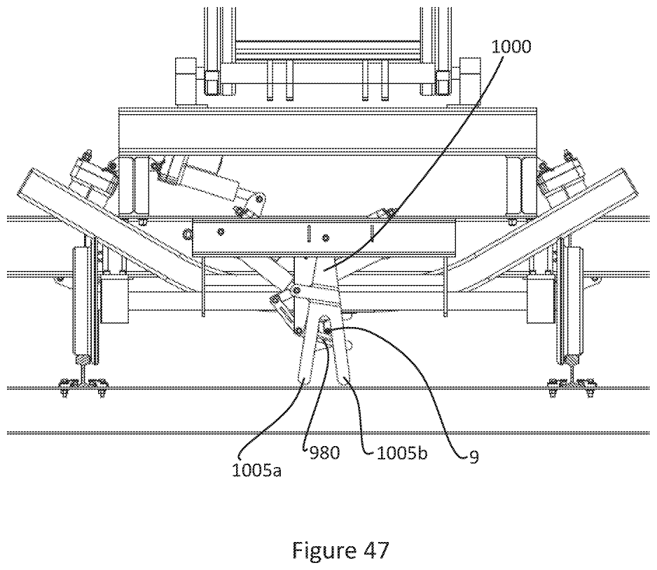

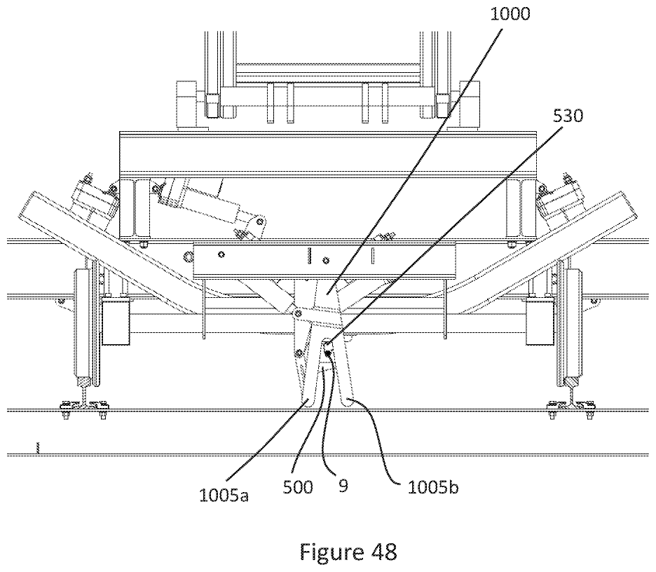

In operation, the rope guide actuator 1010 drives the rope guide arm 1015 to move the rope guide 1000 into engagement with the rope 9 via one arm 1005a, as best shown in FIG. 42. The rope guide 1000 continues to move the rope 9 until it is in a first intermediate position, just past the holding assembly 500, as best shown in FIG. 43. The second actuator 990 then moves the second rope engagement member 980 to engage the rope 9 in the first intermediate position, as best shown in FIG. 44. The second rope engagement member 980 then continues to move the rope 9 along the yoke arm 1005a of the rope guide 1000 to a second intermediate position, as best shown in FIG. 45, where the rope 9 is above and laterally displaced from the channel 530 of the holding assembly 500. The rope guide actuator 1010 then moves the rope guide 1000 back towards its original position so that the other yoke arm 1005b engages the rope 9. The yoke arm 1005b then moves the rope 9 along the second rope engagement member 980 towards the channel 530, as best shown in FIG. 46. The second rope engagement member 980 disengages from the rope 9, as best shown in FIG. 47. The rope 9 then falls into the channel 530 of the holding assembly 500, as best shown in FIG. 48. At the same time, the second rope engagement member 980 and rope guide 1000 are returned to their original positions, also as shown in FIG. 48. The rope 9 is then secured by the transfer assembly 800 by reversing the steps described above in relation to FIGS. 30 to 35. The rope guide 1000 in this instance ensures that the rope 9 is fully removed from the channel 530 and the holding assembly 500.

The rope removal mechanism 910 and rope replacement mechanism 920 of the transfer mechanism 600a, 600b may be located at either end or both ends of the carriage connecting frame 420a, 420b of the conveyor mechanism 400a, 400b, preferably in front or rear of the axles of the wheels 6 of the carriages 5, 50, 52. In some embodiments, the rope removal mechanism 910 and rope replacement mechanism 920 are located at the same end of the carriage connecting frame 420a, 420b. In other embodiments, the rope removal mechanism 910 is located at one end of the carriage connecting frame 420a, 420b and the rope replacement mechanisms 920 is located at the other end of the carriage connecting frame 420a, 420b holding assembly 500. In yet another embodiment, there are two pairs of the rope removal mechanism 910 and rope replacement mechanism 920, one pair of the rope removal mechanism and rope replacement mechanism at each end of the carriage connecting frame 420a, 420b. The pairs of the rope removal mechanism 910 and rope replacement mechanism 920 may be mirrored relative to each other from their respective carriage ends. The arrangement chosen will depend on the rope tension in the rail conveyor 1. However, it may be preferable to have two pairs of the rope removal mechanism 910 and rope replacement mechanism 920 to reduce the load on the actuators 930, 960, 990 and 1010 in the mechanisms.

It should also be noted that the rope removal mechanism 910 and rope replacement mechanism 920 of the transfer mechanism 600a, 600b may also be used for other types of carriages, such as the single and double yoke carriages described above, as well as carriages using the compression spring 560 mounted to the rope 9.

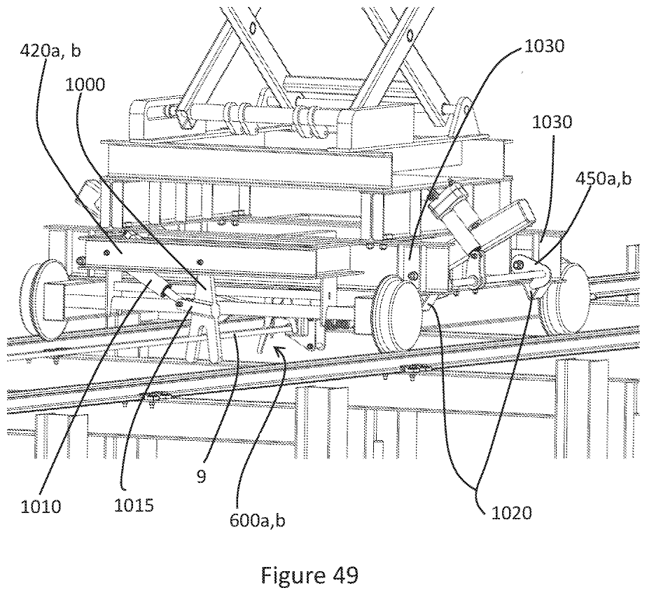

In addition, the rope guide 1000 may also be adapted for use with the transfer mechanism 600a, 600b described in relation to FIGS. 15 to 21. Referring to FIG. 49, the rope guide 1000 with its actuator 1010 and guide arm 1015 have been installed at the front of the carriage connecting frame 420a, 420b and the transfer mechanism 600a, 600b. In this case, the rope guide 1000 ensures that the rope 9 moves into the receiving portion 618a, 618b of the rope engagement member 610a, 610b. The rope guide 1000 also ensures that the rope is moved fully out of the holding assembly 500.

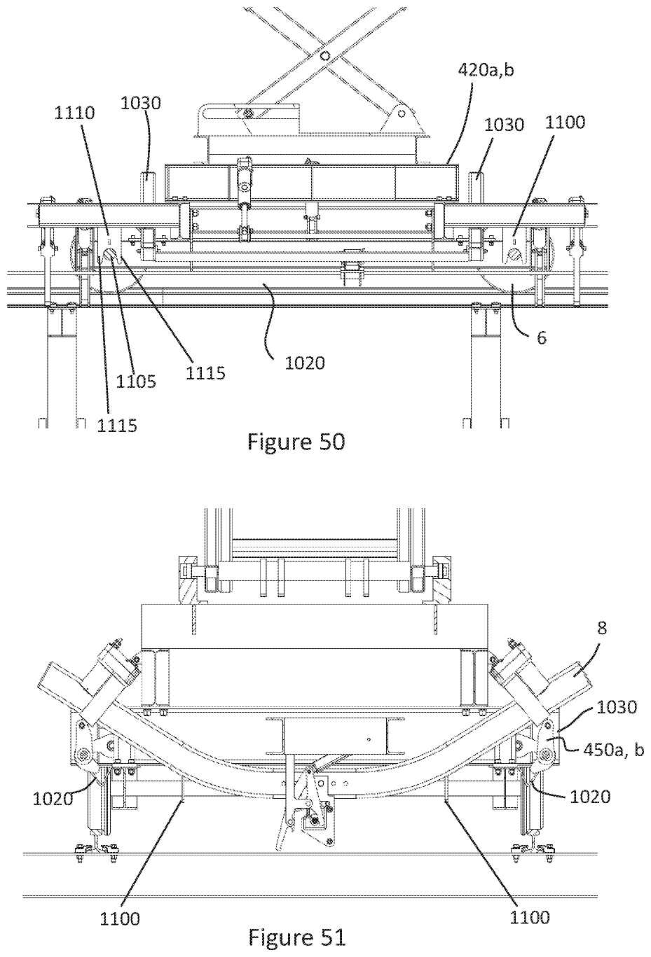

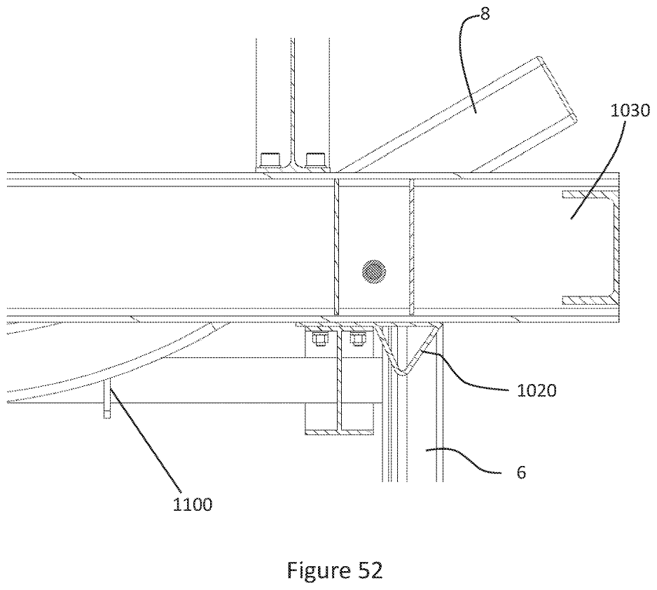

In a further embodiment, the carriage connecting frame 420a, 420b may have frame guides 1020 for guiding the carriage connecting frame into engagement with the selected carriage 50, as best shown in FIGS. 49 to 52. FIG. 49 shows the frame guides 1020 for guiding a single yoke carriage, while FIGS. 50 to 52 shows the frame guides for guiding a double yoke carriage. The frame guides 1020 are fixed to a pair of cross beams 1030 of the carriage connecting frame 420a, 420b, as best shown in FIGS. 50, 51 and 52. The cross beams 1030 may be integrated with the carriage engagement members 425a, 426a. The frame guides 1020 extend generally parallel to the sides of the selected carriage 50, as best shown in FIG. 50. In this way, the frame guide members 1020 guide the selected carriage 50 to substantially perpendicular to the rail track 2. That is, the selected carriage 50 is positioned for engagement with the carriage connecting frame 420a, 420b in the substantially perpendicular direction. The frame guides 1020 are also triangular or wedge-shaped in cross-section, as best shown in FIG. 52. However, in other embodiments may adopt other regular and irregular polygonal cross-sectional shapes, including rectangular, spherical, oval, hexagonal or shapes with rounded edges.

The carriage connecting frame 420a, 420b may also have one or more locating members for locating the selected carriage relative to the conveyor mechanism. In one or more embodiments, the one or more locating members 1100 to locate the selected carriage 5 to be inline or axially aligned with the rail track 2. The locating members 1100 engage the axle 1105 of the selected carriage 50. In this embodiment, the locating members each have a detent portion 1110 for engaging the axle 1105. The locating members 1100 thus have two “teeth” or arms 1115 on either side of the detent portion 1110. The locating members 1100 locate the selected carriage 50 relative to the conveyor mechanism 400a, 400b via the carriage connecting frame 420a, 420b.

While the embodiments of the invention have been described in replacing carriages in a rail conveyor system 1 using carriages 5 spaced apart from each other and connected to a rope 9, it will be appreciated that the invention can be applied to other rail type conveyor systems. For example, the system 100 can be adapted for use with gondola-type rail conveyor systems, where carriages or baskets are suspended from a cable or rope and travel along the cable/rope defining a “rail” using a wheeled roller. In this case, the frame assembly 200 would be located above the cableway or ropeway and the transportation assemblies 300a, 300b are configured to remove and replace a selected carriage from the rope as it travels along in substantially the same way as described above.

It will further be appreciated that any of the features in the preferred embodiments of the invention can be combined together and are not necessarily applied in isolation from each other. For example, the pistons 640a, 640b can be replaced with linear actuators similar to those used by the hooks 450a, 450b in the carriage engagement frame 420a, 420b. Similar combinations of two or more features from the above described embodiments or preferred forms of the invention can be readily made by one skilled in the art.

Similarly, the system 100 can be utilised where the rail track 2 has been arranged so that the carriages 5 are transferred from the delivery run to the return run over a turnover wheel to minimise the footprint of the turnaround loops, as disclosed in International patent application PCT/AU2015/000655, published as WO 2016/065406 A1, and as illustrated in FIG. 1B. Here, the frame assembly 200 would be incorporated into the support structure of the rail conveyor 1 system and positioned before the belt 10 is lowered onto the carriages 5 along the return run 30, or alternatively, after the belt 10 is removed from the carriages along the return run.

By providing a frame assembly that travels at substantially the same speed as the carriages in a rail conveyor and supports a transportation assembly that is able to remove and/or replace a carriage as the carriages move, without having to stop the rail conveyor, the invention confers the advantages of reducing or eliminating downtime for the rail conveyor, reduces time and labour in performing maintenance and improves worker safety. For example, by providing a system that can remove and/or replace carriages in situ without having to stop the rail conveyor 1, the amount of downtime for the roller conveyor is minimised or eliminated. In addition, as the system is capable of automation, there is no need to mechanically and electrically isolate the rail conveyor 1 and so removes the need for personnel to work in hazardous environments. It also leads to a reduction in manual labour and the need to provide safety protection measures for personnel in relation to the removal and/or replacement operation. Thus, it can be seen from the above description that the present invention provides significant advantages over the prior art. Furthermore, the invention can be readily implemented to existing rail conveyor systems as an add-on in the turnaround loops, and so can be retrofitted. In all these respects, the invention represents a practical and commercially significant improvement over the prior art.

1. A system for performing maintenance on a rail conveyor having a plurality of carriages removably connected to each other, wherein each carriage comprises wheels for running along a rail track, comprising:
a frame assembly configured for moving parallel to the rail track;
a transportation assembly mounted to the frame assembly; the transportation assembly being configured to:
move relative to the frame assembly and into proximity to a selected carriage of the plurality of carriages;
detach the selected carriage from the plurality of carriages; and
remove the selected carriage from the rail track.

2. The system of claim 1, wherein the frame assembly is configured to move at substantially the same speed as the plurality of carriages and/or is configured to remove the selected carriage from the rail track as the plurality of carriages move along the rail track.

3. The system of claim 1, wherein the transportation assembly comprises a conveyor mechanism for removing the selected carriage from the rail track, wherein the conveyor mechanism comprises a lifting mechanism for lifting the selected carriage from the rail track.

4. The system of claim 3, wherein the lifting mechanism comprises a mechanical lifting device having at least one of a scissor lift, hoist, telescopic arm, telescopic crane or lifting arm.

5. The system of claim 3, wherein the conveyor mechanism comprises a carriage connecting member for removably connecting the lifting mechanism to the selected carriage, wherein the carriage connecting member comprises one or more carriage engagement members having one or more removable locking elements for securing the selected carriage to the lifting mechanism.

6. The system of claim 1, wherein the transportation assembly comprises a transfer mechanism for detaching the selected carriage from the plurality of carriages, wherein the plurality of carriages are spaced apart from each other and are each removably connected to a rope, the transfer mechanism comprising a first rope engagement member for engaging the rope and detaching the rope from the selected carriage, the first rope engagement member being connected to a first actuator for moving the rope engagement member into and out of engagement with the rope.

7. The system of claim 6, wherein the first actuator comprises an actuator arm connected to a drive member, the first rope engagement member being pivotally connected to the actuator arm such that the drive member operates the actuator arm to pivot the first rope engagement member, and wherein the first rope engagement member comprises a catch portion for capturing the rope and a transfer arm for moving the rope from the catch portion to a receiving portion, such that catch portion captures the rope, the transfer arm moves the rope from the catch portion to the receiving portion and the receiving portion releases the rope to detach the rope from the selected carriage.

8. The system of claim 7, wherein the transfer mechanism is configured to attach the rope to a replacement carriage, in which the receiving portion of the second transportation assembly receives the rope, the transfer arm moves the rope to the catch portion, and the catch portion releases the rope into a holding portion of the replacement carriage.

9. The system of claim 6, wherein the first actuator comprises an actuator arm pivotally connected to the first rope engagement member such that the actuator arm pivots the first rope engagement member to displace the rope from the selected carriage, the system further comprising a transfer arm operably connected to a transfer actuator, wherein the transfer arm removes the rope from the first rope engagement member, thereby detaching the rope from the selected carriage.

10. The system of claim 6, wherein the transfer mechanism is configured to attach the rope to a replacement carriage, the transfer mechanism comprising a second rope engagement member for engaging the rope and attaching the rope to the replacement carriage, the second rope engagement member being connected to a second actuator for moving the rope engagement member into and out of engagement with the rope.

11. The system of claim 10, wherein the transfer mechanism comprises a rope guide for guiding movement of the rope, the rope guide being movable to guide the rope into engagement with the second rope engagement member and move the rope relative to the second rope engagement member such that the second rope engagement member is able to release the rope into a holding portion of the replacement carriage, thereby attaching the rope to the replacement carriage.

12. The system of claim 6, wherein the selected carriage comprises a locating member for locating the rope in a holding portion of the selected carriage, wherein the transfer mechanism comprises a pivot member for moving the locating member to enable the rope to leave the holding portion and/or provide a clearance space for the first rope engagement member to engage and detach the rope from the selected carriage, wherein the pivot member is connected to the actuator arm such that movement of the actuator arm causes the pivot member to move the locating member.

13. The system of any claim 6, wherein the selected carriage comprises a locating member for locating the rope in a holding portion of the selected carriage, wherein a transfer assembly is configured to move the locating member to enable the rope to leave the holding portion and/or provide a clearance space for the first rope engagement member to engage and detach the rope from the selected carriage, the transfer assembly comprising a transfer arm operably connected to a transfer rod such that the transfer arm moves the transfer rod to engage and move the locating member.

14. The system of claim 1, further comprising a support track elevated above the rail track, the support track having rails extending parallel to the rail track, wherein the frame assembly is moveable along the support track, the frame assembly comprising a bridge portion extending between the rails of the support track and a plurality of wheels for moving the bridge portion along the support track, and wherein the transportation assembly is mounted to the bridge portion for movement substantially transverse to the direction of the rail track.

15. The system of claim 1, wherein the plurality of carriages each comprises one or more tension or compression springs mounted to a frame of each of the plurality of carriages.

16. The system of claim 1, wherein there are a plurality of the transportation assemblies, comprising at least a first transportation assembly and a second transportation assembly, wherein the first transportation assembly is operable to remove the selected carriage and the second transportation assembly is operable to replace the selected carriage with a replacement carriage.

17. The system of claim 16, wherein:
the conveyor mechanism of the second transportation assembly is operable to move the replacement carriage onto the rail track as the plurality of carriages move along the rail track; and
the transfer mechanism of the second transportation assembly is operable to attach the replacement carriage to the plurality of carriages.

18. A method for performing maintenance on a rail conveyor having a plurality of carriages removably connected to each other and are each removably connected to a rope, wherein each carriage comprises wheels for running along a rail track, the method comprising the steps of:
moving a frame assembly parallel to the rail track;
moving a transportation assembly relative to the frame assembly into proximity to a selected carriage of the plurality of carriages;
detaching the selected carriage from the plurality of carriages; and
removing the selected carriage from the rail track.

19. The method of claim 18, further comprising moving the frame assembly at substantially the same speed as the plurality of carriages and moving the transportation assembly substantially transverse to the direction of the rail track, wherein the removing step comprises removing the selected carriage from the rail track with a conveyor mechanism of the transportation assembly as the plurality of carriages move along the rail track.

20. The method of claim 19, wherein the removing step comprises the conveyor mechanism lifting the selected carriage from the rail track and removably locking the selected carriage to the conveyor mechanism to secure the selected carriage prior to removing the selected carriage, and wherein the transportation assembly has a transfer mechanism, wherein the detaching step comprises locating the transfer mechanism relative to the selected carriage and detaching the rope from the selected carriage by engaging the rope with a first rope engagement member.

21. The method of claim 18, wherein there is a plurality of the transportation assemblies, comprising at least a first transportation assembly and a second transportation assembly, and the first transportation assembly performs the detaching and removing steps, the method further comprising replacing the selected carriage with a replacement carriage using the second transportation assembly, wherein the replacing step comprises the second transportation assembly moving the replacement carriage to the rail track as the plurality of carriages move along the rail track, lowering the replacement carriage onto the rail track into the space left by the selected carriage in the plurality of carriages and attaching the replacement carriage to the plurality of carriages.
